(19) United States
(12) Patent Application Publication
(10) Pub. No.: US 2011/0231484 A1
(43) Pub. Date: Sep. 22, 2011

(54) TV Internet Browser

(75) Inventors: John Townsend BURGESS, III, Washington, DC (US); Neel GOYAL, Reston, VA (US); Frank A. HUNLETH, Rockville, MD (US)

(73) Assignee: HILLCREST LABORATORIES, INC., Rockville, MD (US)

(21) Appl. No.: 13/053,548

(22) Filed: Mar. 22, 2011

Related U.S. Application Data
(60) Provisional application No. 61/316,244, filed on Mar. 22, 2010.

(51) Int. Cl. G06F 15/16

(52) U.S. Cl. 709/203

(57) ABSTRACT

Inputs toward a TV Internet Browser are selectively remapped to enable proper operation of the browser. For example, back commands can be remapped into escape commands when the browser is displaying content using a FLASH or SILVERLIGHT plug-in module.

### RELATED APPLICATION

This application is related to, and claims priority from, U.S. Provisional Patent Application Ser. No. 61/316,244, filed on Mar. 22, 2010, entitled “TV Internet Browser”, the disclosure of which is hereby incorporated by reference.

### BACKGROUND

This application describes, among other things, an Internet browser.

Technologies associated with the communication of information have evolved rapidly over the last several decades. Television, cellular telephony, the Internet and optical communication techniques (to name just a few things) combine to inundate consumers with available information and entertainment options. Taking television as an example, the last three decades have seen the introduction of cable television service, satellite television service, pay-per-view movies and video-on-demand. Whereas television viewers of the 1960s could typically receive perhaps four or five over-the-air TV channels on their television sets, today's TV watchers have the opportunity to select from hundreds, thousands, and potentially millions of channels of shows and information. Video-on-demand technology, currently used primarily in hotels and the like, provides the potential for in-home entertainment selection from among thousands of movie titles.

The technological ability to provide so much information and content to end users provides both opportunities and challenges to system designers and service providers. One challenge is that while end users typically prefer having more choices rather than fewer, this preference is counterweighted by their desire that the selection process be both fast and simple. Unfortunately, the development of the systems and interfaces by which end users access media items has resulted in selection processes which are neither fast nor simple. Consider again the example of television programs. When television was in its infancy, determining which program to watch was a relatively simple process primarily due to the small number of choices. One would consult a printed guide which was formatted, for example, as series of columns and rows which showed the correspondence between (1) nearby television channels, (2) programs being transmitted on those channels and (3) date and time. The television was tuned to the desired channel by adjusting a tuner knob and the viewer watched the selected program. Later, remote control devices were introduced that permitted viewers to tune the television from a distance. This addition to the user-television interface created the phenomenon known as “channel surfing” whereby a viewer could rapidly view short segments being broadcast on a number of channels to quickly learn what programs were available at any given time.

Despite the fact that the number of channels and amount of viewable content has dramatically increased, the generally available user interface, control device options and frameworks for televisions has not changed much over the last 30 years. Printed guides are still the most prevalent mechanism for conveying programming information. The multiple button remote control with up and down arrows is still the most prevalent channel/content selection mechanism. The reaction of those who design and implement the TV user interface to the increase in available media content has been a straightforward extension of the existing selection procedures and interface objects. Thus, the number of rows in the printed guides has been increased to accommodate more channels. The number of buttons on the remote control devices has been increased to support additional functionality and content handling, e.g., as shown in FIG. 1. However, this approach has significantly increased both the time required for a viewer to review the available information and the complexity of actions required to implement a selection. Arguably, the cumbersome nature of the existing interface has hampered commercial implementation of some services, e.g., video-on-demand, since consumers are resistant to new services that will add complexity to an interface that they view as already too slow and complex.

In addition to increases in bandwidth and content, the user interface bottleneck problem is being exacerbated by the aggregation of technologies. Consumers are reacting positively to having the option of buying integrated systems rather than a number of segregable components. An example of this trend is the combination television/VCR/DVD in which three previously independent components are frequently sold today as an integrated unit. This trend is likely to continue, potentially with an end result that most if not all of the communication devices currently found in the household will be packaged together as an integrated unit, e.g., a television/VCR/DVD/internet access/radio/stereo unit. Even those who continue to buy separate components will likely desire seamless control of, and interworking between, the separate components. With this increased aggregation comes the potential for more complexity in the user interface. For example, when so-called “universal” remote units were introduced, e.g., to combine the functionality of TV remote units and VCR remote units, the number of buttons on these universal remote units was typically more than the number of buttons on either the TV remote unit or VCR remote unit individually. This added number of buttons and functionality makes it very difficult to control anything but the simplest aspects of a TV or VCR without hunting for exactly the right button on the remote. Many times, these universal remotes do not provide enough buttons to access many levels of control or features unique to certain TVs. In these cases, the original device remote unit is still needed, and the original hassle of handling multiple remotes remains due to user interface issues arising from the complexity of aggregation. Some remote units have addressed this problem by adding “soft” buttons that can be programmed with the expert commands. These soft buttons sometimes have accompanying LCD displays to indicate their action. These too have the flaw that they are difficult to use without looking away from the TV to the remote control. Yet another flaw in these remote units is the use of modes in an attempt to reduce the number of buttons. In these “moded” universal remote units, a special button exists to select whether the remote should communicate with the TV, DVD player, cable set-top box, VCR, etc. This causes many usability issues including sending commands to the wrong device, forcing the user to look at the remote to make sure that it is in the right mode, and it does not provide any simplification to the integration of multiple devices. The most advanced of these universal remote units provide some integration by allowing the user to program sequences of commands to multiple devices into the remote. This is such a difficult task that many users hire professional installers to program their universal remote units.

Some attempts have also been made to modernize the screen interface between end users and media systems. However, these attempts typically suffer from, among other drawbacks, an inability to easily scale between large collections of media items and small collections of media items. For example, interfaces which rely on lists of items may work well for small collections of media items, but are tedious to browse for large collections of media items. Interfaces which rely on hierarchical navigation (e.g., tree structures) may be speedier to traverse than list interfaces for large collections of media items, but are not readily adaptable to small collections of media items. Additionally, users tend to lose interest in selection processes wherein the user has to move through three or more layers in a tree structure. For all of these cases, current remote units make this selection process even more tedious by forcing the user to repeatedly depress the up and down buttons to navigate the list or hierarchies. When selection skipping controls are available such as page up and page down, the user usually has to look at the remote to find these special buttons or be trained to know that they even exist. Accordingly, organizing frameworks, techniques and systems which simplify the control and screen interface between users and media systems as well as accelerate the selection process, while at the same time permitting service providers to take advantage of the increases in available bandwidth to end user equipment by facilitating the supply of a large number of media items and new services to the user have been proposed in U.S. patent application Ser. No. 10/768,432, filed on Jan. 30, 2004, entitled “A Control Framework with a Zoomable Graphical User Interface for Organizing, Selecting and Launching Media Items”, the disclosure of which is incorporated here by reference.

Of particular interest for this specification are the remote devices usable to interact with such frameworks, as well as other applications, systems and methods for these remote devices for interacting with such frameworks. As mentioned in the above-incorporated application, various different types of remote devices can be used with such frameworks including, for example, trackballs, “mouse”-type pointing devices, light pens, etc. However, another category of remote devices which can be used with such frameworks (and other applications) is 3D pointing devices with scroll wheels. The phrase “3D pointing” is used in this specification to refer to the ability of an input device to move in three (or more) dimensions in the air in front of, e.g., a display screen, and the corresponding ability of the user interface to translate those motions directly into user interface commands, e.g., movement of a cursor on the display screen. The transfer of data between the 3D pointing device may be performed wirelessly or via a wire connecting the 3D pointing device to another device. Thus “3D pointing” differs from, e.g., conventional computer mouse pointing techniques which use a surface, e.g., a desk surface or mousepad, as a proxy surface from which relative movement of the mouse is translated into cursor movement on the computer display screen. An example of a 3D pointing device can be found in U.S. patent application Ser. No. 11/119,663, the disclosure of which is incorporated here by reference.

### SUMMARY

Inputs toward a TV Internet Browser are selectively remapped to enable proper operation of the browser. For example, back commands can be remapped into escape commands when the browser is displaying content using a FLASH or SILVERLIGHT plug-in module.

According to one embodiment, a method for remapping button press inputs to a TV Internet browser includes the steps of receiving a button press input associated with a predetermined command, determining whether a currently viewed web page on the TV Internet browser is running a predetermined plug-in in a predetermined mode, if so, remapping the button press input from the predetermined command to another command which is intended to terminate the predetermined plug-in and sending the another command to the TV Internet browser, and if not, sending the back command to the TV Internet browser.

### BRIEF DESCRIPTION OF THE DRAWINGS

The accompanying drawings illustrate exemplary embodiments of the present invention, wherein:

FIG. 1 depicts a conventional remote control unit for an entertainment system;

FIG. 2 depicts an exemplary media system in which exemplary embodiments of the present invention can be implemented;

FIG. 3(a) shows a 3D pointing device according to an exemplary embodiment of the present invention;

FIG. 3(b) illustrates a user employing a 3D pointing device to provide input to a user interface on a television according to an exemplary embodiment of the present invention;

FIG. 4 shows the global navigation objects of FIG. 3(b) in more detail according to an exemplary embodiment of the present invention;

FIG. 5 depicts a zooming transition as well as a usage of an up function global navigation object according to an exemplary embodiment of the present invention;

FIG. 6 shows a search tool which can be displayed as a result of actuation of a search global navigation object according to an exemplary embodiment of the present invention;

FIG. 7 shows a live TV UI view which can be reach via actuation of a live TV global navigation object according to an exemplary embodiment of the present invention;

FIGS. 8 and 9 depict channel changing and volume control overlays which can be rendered visible on the live TV UI view of FIG. 7 according to an exemplary embodiment of the present invention;

FIG. 10 shows an electronic program guide view having global navigation objects according to an exemplary embodiment of the present invention;

FIGS. 11(a)-11(w) show an Internet browser according to an exemplary embodiment of the present invention;

FIG. 12 depicts a remap function disposed between a 3D pointing device and a TV Internet Browser according to an exemplary embodiment; and

FIG. 13 is a flowchart showing a method for remapping inputs to a TV Internet Browser according to an exemplary embodiment.

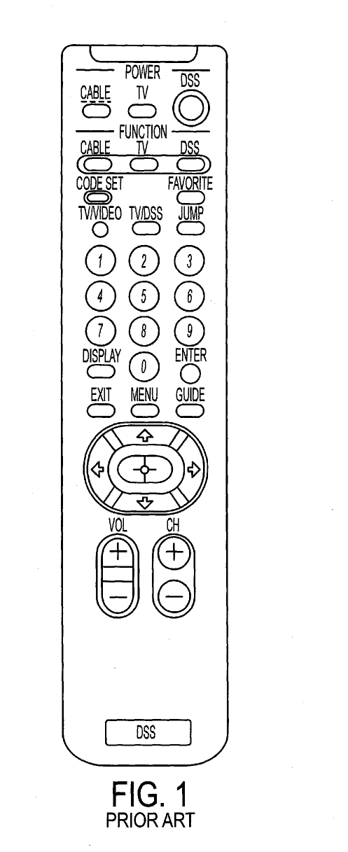

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims.

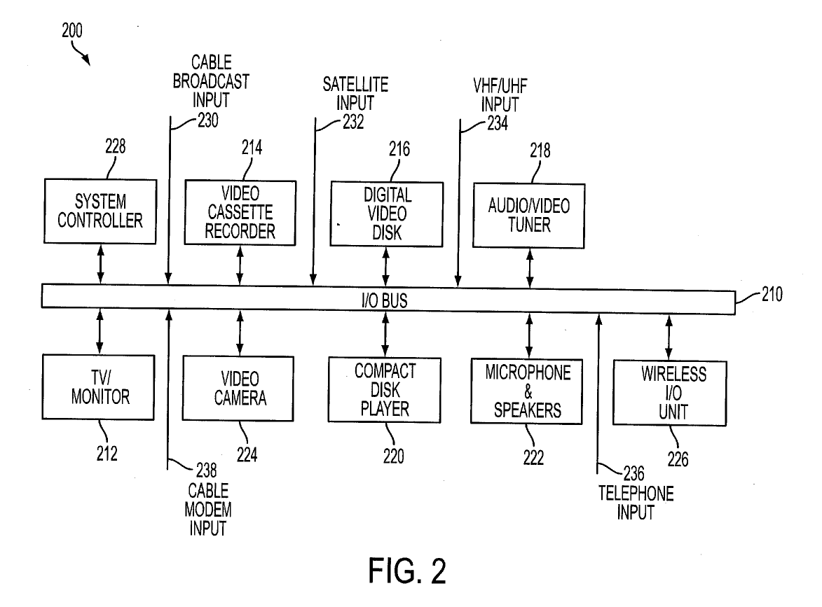

In order to provide some context for this discussion, an exemplary aggregated media system 200 in which the present invention can be implemented will first be described with respect to FIG. 2. Those skilled in the art will appreciate, however, that the present invention is not restricted to implementation in this type of media system and that more or fewer components can be included therein. Therein, an input/output (I/O) bus 210 connects the system components in the media system 200 together. The I/O bus 210 represents any of a number of different of mechanisms and techniques for routing signals between the media system components. For example, the I/O bus 210 may include an appropriate number of independent audio “patch” cables that route audio signals, coaxial cables that route video signals, two-wire serial lines or infrared or radio frequency transceivers that route control signals, optical fiber or any other routing mechanisms that route other types of signals.

In this exemplary embodiment, the media system 200 includes a television/monitor 212, a video cassette recorder (VCR) 214, digital video disk (DVD) recorder/playback device 216, audio/video tuner 218 and compact disk player 220 coupled to the I/O bus 210. The VCR 214, DVD 216 and compact disk player 220 may be single disk or single cassette devices, or alternatively may be multiple disk or multiple cassette devices. They may be independent units or integrated together. In addition, the media system 200 includes a microphone/speaker system 222, video camera 224 and a wireless I/O control device 226. According to exemplary embodiments of the present invention, the wireless I/O control device 226 is a 3D pointing device. The wireless I/O control device 226 can communicate with the entertainment system 200 using, e.g., an IR or RF transmitter or transceiver. Alternatively, the I/O control device can be connected to the entertainment system 200 via a wire.

The entertainment system 200 also includes a system controller 228. According to one exemplary embodiment of the present invention, the system controller 228 operates to store and display entertainment system data available from a plurality of entertainment system data sources and to control a wide variety of features associated with each of the system components. As shown in FIG. 2, system controller 228 is coupled, either directly or indirectly, to each of the system components, as necessary, through I/O bus 210. In one exemplary embodiment, in addition to or in place of I/O bus 210, system controller 228 is configured with a wireless communication transmitter (or transceiver), which is capable of communicating with the system components via IR signals or RF signals. Regardless of the control medium, the system controller 228 is configured to control the media components of the media system 200 via a graphical user interface described below.

As further illustrated in FIG. 2, media system 200 may be configured to receive media items from various media sources and service providers. In this exemplary embodiment, media system 200 receives media input from and, optionally, sends information to, any or all of the following sources: cable broadcast 230, satellite broadcast 232 (e.g., via a satellite dish), very high frequency (VHF) or ultra high frequency (UHF) radio frequency communication of the broadcast television networks 234 (e.g., via an aerial antenna), telephone network 236 and cable modem 238 (or another source of Internet content). Those skilled in the art will appreciate that the media components and media sources illustrated and described with respect to FIG. 2 are purely exemplary and that media system 200 may include more or fewer of both. For example, other types of inputs to the system include AM/FM radio and satellite radio.

More details regarding this exemplary entertainment system and frameworks associated therewith can be found in the above-incorporated by reference U.S. patent application “A Control Framework with a Zoomable Graphical User Interface for Organizing, Selecting and Launching Media Items”. Alternatively, remote devices and interaction techniques between remote devices and user interfaces in accordance with the present invention can be used in conjunction with other types of systems, for example computer systems including, e.g., a display, a processor and a memory system or with various other systems and applications.

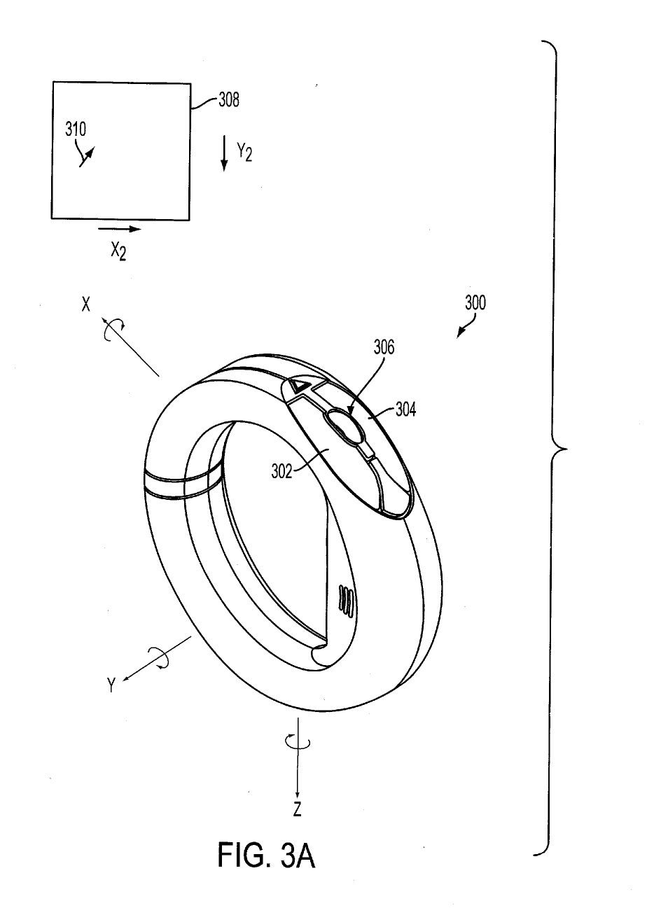

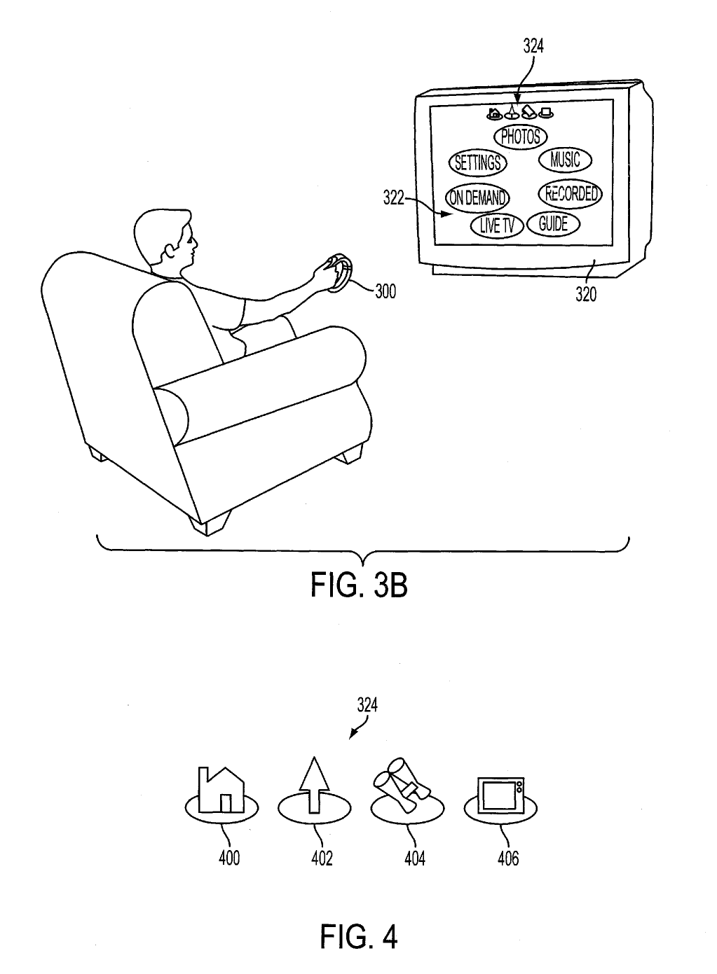

As mentioned in the Background section, remote devices which operate as 3D pointers are of particular interest for the present specification, although the present invention is not limited to systems including 3D pointers. Such devices enable the translation of movement of the device, e.g., linear movement, rotational movement, acceleration or any combination thereof, into commands to a user interface. An exemplary loop-shaped, 3D pointing device 300 is depicted in FIG. 3(a), however the present invention is not limited to loop-shaped devices. In this exemplary embodiment, the 3D pointing device 300 includes two buttons 302 and 304 as well as a scroll wheel 306 (scroll wheel 306 can also act as a button by depressing the scroll wheel 306), although other exemplary embodiments will include other physical configurations. User movement of the 3D pointing device 300 can be defined, for example, in terms of rotation about one or more of an x-axis attitude (roll), a y-axis elevation (pitch) or a z-axis heading (yaw). In addition, some exemplary embodiments of the present invention can additionally (or alternatively) measure linear movement of the 3D pointing device 300 along the x, y, and/or z axes to generate cursor movement or other user interface commands. An example is provided below. A number of permutations and variations relating to 3D pointing devices can be implemented in systems according to exemplary embodiments of the present invention. The interested reader is referred to U.S. patent application Ser. No. 11/119,663, entitled (as amended) “3D Pointing Devices and Methods”, filed on May 2, 2005, U.S. patent application Ser. No. 11/119,719, entitled (as amended) “3D Pointing Devices with Tilt Compensation and Improved Usability”, also filed on May 2, 2005, U.S. patent application Ser. No. 11/119,987, entitled (as amended) “Methods and Devices for Removing Unintentional Movement in 3D Pointing Devices”, also filed on May 2, 2005, and U.S. patent application Ser. No. 11/119,688, entitled “Methods and Devices for Identifying Users Based on Tremor”, also filed on May 2, 2005, the disclosures of which are incorporated here by reference, for more details regarding exemplary 3D pointing devices which can be used in conjunction with exemplary embodiments of the present invention.

According to exemplary embodiments of the present invention, it is anticipated that 3D pointing devices 300 will be held by a user in front of a display 308 and that motion of the 3D pointing device 300 will be translated by the 3D pointing device into output which is usable to interact with the information displayed on display 308, e.g., to move the cursor 310 on the display 308. For example, such 3D pointing devices and their associated user interfaces can be used to make media selections on a television as shown in FIG. 3(b), which will be described in more detail below. Aspects of exemplary embodiments of the present invention can be optimized to enhance the user's experience of the so-called “10-foot” interface, i.e., a typical distance between a user and his or her television in a living room. For example, interactions between pointing, scrolling, zooming and panning, e.g., using a 3D pointing device and associated user interface, can be optimized for this environment as will be described below, although the present invention is not limited thereto.

Referring again to FIG. 3(a), an exemplary relationship between movement of the 3D pointing device 300 and corresponding cursor movement on a user interface will now be described. Rotation of the 3D pointing device 300 about the y-axis can be sensed by the 3D pointing device 300 and translated into an output usable by the system to move cursor 310 along the y₂ axis of the display 308. Likewise, rotation of the 3D pointing device 308 about the z-axis can be sensed by the 3D pointing device 300 and translated into an output usable by the system to move cursor 310 along the x₂ axis of the display 308. It will be appreciated that the output of 3D pointing device 300 can be used to interact with the display 308 in a number of ways other than (or in addition to) cursor movement, for example it can control cursor fading, volume or media transport (play, pause, fast-forward and rewind). Additionally, the system can be programmed to recognize gestures, e.g., predetermined movement patterns, to convey commands in addition to cursor movement. Moreover, other input commands, e.g., a zoom-in or zoom-out on a particular region of a display (e.g., actuated by pressing button 302 to zoom-in or button 304 to zoom-out), may also be available to the user.

Returning now to the application illustrated in FIG. 3(b), the GUI screen (also referred to herein as a “UI view”, which terms refer to a currently displayed set of UI objects) seen on television 320 is a home view. In this particular exemplary embodiment, the home view displays a plurality of applications 322, e.g., “Photos”, “Music”, “Recorded”, “Guide”, “Live TV”, “On Demand”, and “Settings”, which are selectable by the user by way of interaction with the user interface via the 3D pointing device 300. Such user interactions can include, for example, pointing, scrolling, clicking or various combinations thereof. For more details regarding exemplary pointing, scrolling and clicking interactions which can be used in conjunction with exemplary embodiments of the present invention, the interested reader is directed to U.S. patent application Ser. No. 11/417,764, entitled “METHODS AND SYSTEMS FOR SCROLLING AND POINTING IN USER INTERFACES”, to Frank J. Wroblewski, filed on May 4, 2006, the disclosure of which is incorporated here by reference.

Of particular interest for exemplary embodiments of the present invention are the global navigation objects 324 displayed above the UI objects 322 that are associated with various media applications. Global navigation objects 324 provide short cuts to significant applications, frequently used UI views or the like, without cluttering up the interface and in a manner which is consistent with other aspects of the particular user interface in which they are implemented. Initially some functional examples will be described below, followed by some more general characteristics of global navigation objects according to exemplary embodiments of the present invention.

Although the global navigation objects 324 are displayed in FIG. 3(b) simply as small circles, in actual implementations they will typically convey information regarding their functionality to a user by including an icon, image, text or some combination thereof as part of their individual object displays on the user interface. A purely illustrative example is shown in FIG. 4. Therein, four global navigation objects 400-406 are illustrated. The leftmost global navigation object 400 operates to provide the user with a shortcut to quickly reach a home UI view (main menu). For example, the user can move the 3D pointing device 300 in a manner which will position a cursor (not shown) over the global navigation object 400. Then, by selecting the global navigation object 400, the user interface will immediately display the home view, e.g., the view shown in FIG. 3(b). Other mechanisms can be used to select and actuate the global navigation object 400, as well as the other global navigation objects generally referenced by 324. For example, as described in the above-identified patent application entitled “METHODS AND SYSTEMS FOR SCROLLING AND POINTING IN USER INTERFACES”, to Frank J. Wroblewski, each of the global navigation objects 324 can also be reached by scrolling according to one exemplary embodiment of the present invention.

The other global navigation objects 402 through 406 similarly provide shortcut access to various UI views and/or functionality. For example, global navigation object 402 is an “up” global navigation object. Actuation of this global navigation object will result in the user interface displaying a next “highest” user interface view relative to the currently displayed user interface view. The relationship between a currently displayed user interface view and its next “highest” user interface view will depend upon the particular user interface implementation. According to exemplary embodiments of the present invention, user interfaces may use, at least in part, zooming techniques for moving between user interface views. In the context of such user interfaces, the next “highest” user interface view that will be reached by actuating global navigation object 402 is the UI view which is one zoom level higher than the currently displayed UI view. Thus, actuation of the global navigation object 402 will result in a transition from a currently displayed UI view to a zoomed out UI view which can be displayed along with a zooming transition effect. The zooming transition effect can be performed by progressive scaling and displaying of at least some of the UI objects displayed on the current UI view to provide a visual impression of movement of those UI objects away from an observer. In another functional aspect of the present invention, user interfaces may zoom-in in response to user interaction with the user interface which will, likewise, result in the progressive scaling and display of UI objects that provide the visual impression of movement toward an observer. More information relating to zoomable user interfaces can be found in U.S. patent application Ser. No. 10/768,432, filed on Jan. 30, 2004, entitled “A Control Framework with a Zoomable Graphical User Interface for Organizing, Selecting and Launching Media Items”, and U.S. patent application Ser. No. 09/829,263, filed on Apr. 9, 2001, entitled “Interactive Content Guide for Television Programming”, the disclosures of which are incorporated here by reference.

Movement within the user interface between different user interface views is not limited to zooming. Other non-zooming techniques can be used to transition between user interface views. For example, panning can be performed by progressive translation and display of at least some of the user interface objects which are currently displayed in a user interface view. This provides the visual impression of lateral movement of those user interface objects to an observer.

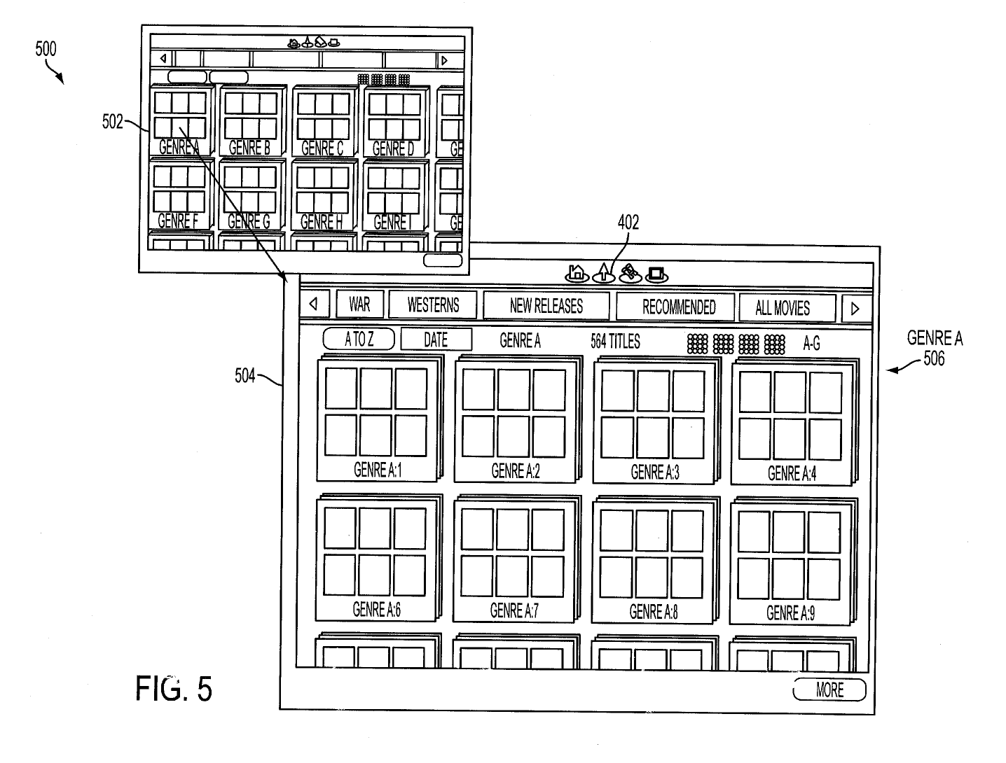

Regardless of the different techniques which are employed in a particular user interface implementation to transition between user interface views, the provision of a global navigation object 402 which provides an up function may be particularly beneficial for user interfaces in which there are multiple paths available for a user to reach the same UI view. For example, consider the UI view 500 shown in FIG. 5. This view illustrates a number of on-demand movie selections, categorized by genre, which view 500 can be reached by, for example, zooming in on the “On Demand” application object shown in the home view of FIG. 3(b). By pressing the zoom-in button 302 on the 3D pointing device 300 one more time, while the current focus (e.g., selection highlighting) is on the UI object associated with “Genre A” 502 in the UI view 500, the user interface will zoom-in on this object to display a new UI view 504. The UI view 504 will display a number of sub-genre media selection objects which can, for example, be implemented as DVD movie cover images. However, this same UI view 504 could also have been reached by following a different path through the user interface, e.g., by actuating a hyperlink 506 from another UI view. Under this scenario, actuating the up global navigation object 402 from UI view 504 will always result in the user interface displaying UI view 502, regardless of which path the user employed to navigate to UI view 504 in the first place. By way of contrast, if the user actuates the zoom-out (or back) button 304 from UI view 504, the user interface will display the previous UI view along the path taken by the user to reach UI view 504. Thus, according to this exemplary embodiment of the present invention, the up global navigation object 504 provides a consistent mechanism for the user to move to a next “highest” level of the interface, while the zoom-out (or back) button 304 on the 3D pointing device 300 provides a consistent mechanism for the user to retrace his or her path through the interface.

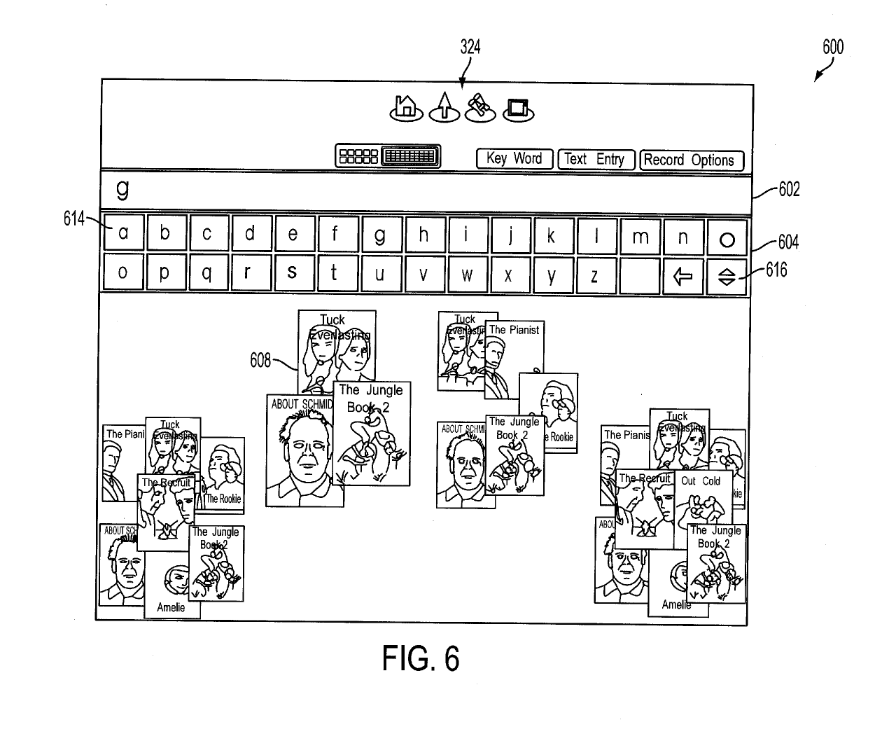

Returning to FIG. 4, global navigation object 404 provides a search function when activated by a user. As a purely illustrative example, the search tool depicted in FIG. 6 can be displayed when a user actuates the global navigation object 404 from any of the UI views within the user interface on which global navigation object 404 is displayed. The exemplary UI view 600 depicted in FIG. 6 contains a text entry widget including a plurality of control elements 604, with at least some of the control elements 604 being drawn as keys or buttons having alphanumeric characters 614 thereon, and other control elements 604 being drawn on the interface as having non-alphanumeric characters 616 which can be, e.g., used to control character entry. In this example, the control elements 604 are laid out in two horizontal rows across the interface, although other configurations may be used.

Upon actuating a control element 604, e.g., by clicking a button on a the 3D pointing device 300 when a particular element 604 has the focus, the corresponding alphanumeric input is displayed in the textbox 602, disposed above the text entry widget, and one or more groups of displayed items related to the alphanumeric input provided via the control element(s) can be displayed on the interface, e.g., below the text entry widget. Thus, the GUI screen depicted in FIG. 6 according to one exemplary embodiment of the present invention can be used to search for selectable media items, and graphically display the results of the search on a GUI screen, in a manner that is useful, efficient and pleasing to the user. (Note that in the illustrated example of FIG. 6, although the letter “g” is illustrated as being displayed in the text box 602, the displayed movie cover images below the text entry widget simply represent a test pattern of DVD movie covers and are not necessarily related to the input letter “g” as they could be in an implementation, e.g., the displayed movie covers could be only those whose movie titles start with the letter “g”). This type of search tool enables a user to employ both keyword searching and visual browsing in a powerful combination that expedites a search across, potentially, thousands of selectable media items. By selecting one of the DVD movie covers, e.g., UI object 608, the user interface can, for example, display a more detailed UI view associated with that movie, along with an option for a user to purchase and view that on-demand movie. As those skilled in the art will appreciate, given a potentially very large number of selectable media items, quick and easy access to a search tool made possible by the provision of global navigation object 404 on most, if not all, of the UI views provided by the user interface, provides the user with convenient access thereto.

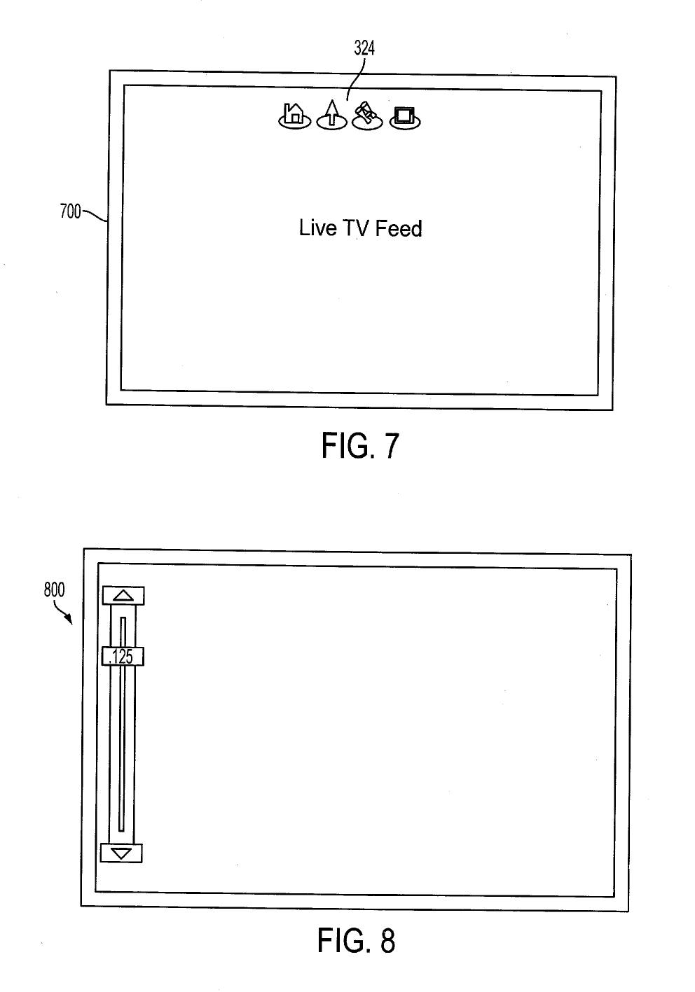

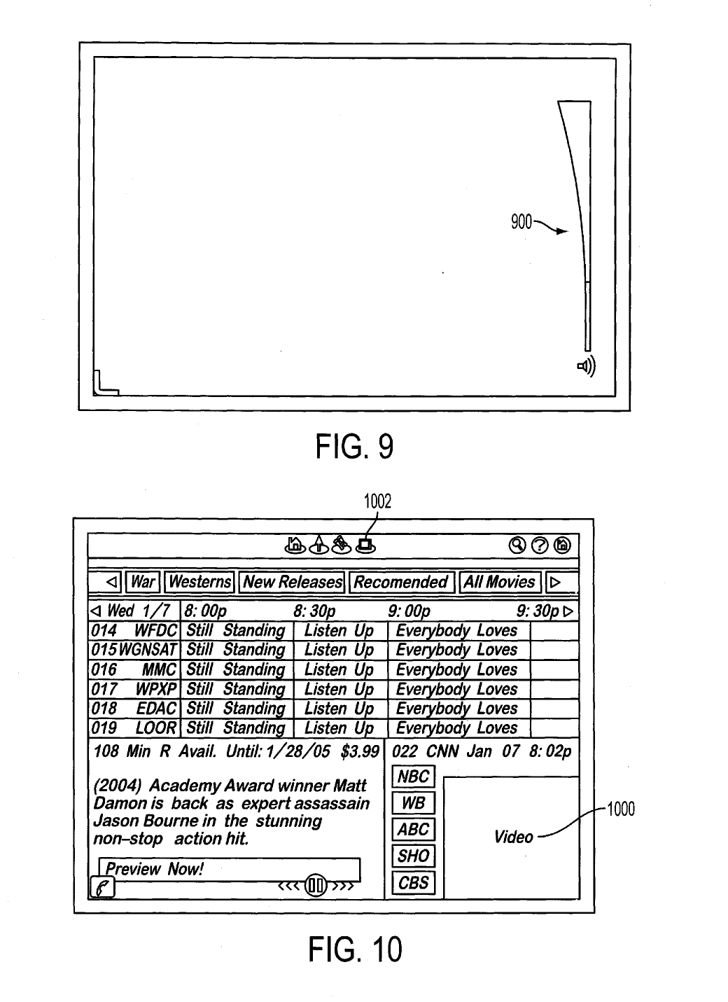

Returning again to FIG. 4, the fourth global navigation object 406 displayed in this exemplary embodiment is a live TV global navigation object. Actuation of the global navigation object 406 results in the user interface immediately displaying a live TV UI view that enables a user to quickly view television programming from virtually any UI view within the interface. An example of a live TV UI view 700 is shown in FIG. 7, wherein it can be seen that the entire interface area has been cleared out of UI objects so that the user has an unimpeded view of the live television programming. A channel selection control overlay 800 (FIG. 8) can be displayed, and used to change channels, in response to movement of the cursor proximate to the leftmost region of the user interface. Similarly a volume control overlay 900 (FIG. 9) can be displayed, and used to change the output volume of the television, in response to movement of the cursor proximate to the rightmost region of the user interface. More information relating to the operation of the channel selection control overlay 800 and volume control overlay 900 can be found in the above-incorporated by reference U.S. patent application entitled “METHODS AND SYSTEMS FOR SCROLLING AND POINTING IN USER INTERFACES”, to Frank J. Wroblewski.

Comparing FIGS. 7, 8 and 9 reveals that the global navigation objects 324 are visible in the UI view 700, but not in the UI views 800 and 900. This visual comparison introduces the different display states of global navigation objects according to exemplary embodiments of the present invention. More specifically, according to one exemplary embodiment of the present invention, the global navigation objects 324 can be displayed in one of three display states: a watermark state, an over state and a non-displayed state. In their watermark (partially visible) state, which is a default display state, each of the global navigation 324 are displayed in a manner so as to be substantially transparent (or faintly filled in) relative to the rest of the UI objects in a given UI view. For example, the global navigation objects can be displayed only as a faint outline of their corresponding icons when in their watermark state. As the default display state, this enables the global navigation objects 324 to be sufficiently visible for the user to be aware of their location and functionality, but without taking the focus away from the substantially opaque UI objects which represent selectable media items.

In their over display state, which is triggered by the presence of a cursor proximate and/or over one of the global navigation objects 324, that global navigation object has its outline filled in to become opaque. Once in its over display state, the corresponding global navigation object 400-406 can be actuated, e.g., by a button click of the 3D pointing device 300.

Lastly, for at least some UI views, the global navigation objects 324 can also have a non-displayed state, wherein the global navigation objects 324 become completely invisible. This non-displayed state can be used, for example, in UI views such as the live TV view 700 where it is desirable for the UI objects which operate as controls to overlay the live TV feed only when the user wants to use those controls. This can be implemented by, for example, having the global navigation objects 324 move from their watermark display state to their non-displayed state after a predetermined amount of time has elapsed without input to the user interface from the user while a predetermined UI view is currently being displayed. Thus, if the live TV view 700 is currently being displayed on the television and the user interface does not receive any input, e.g., motion of the 3D pointing device 300, for more than 3 or 5 seconds, then the global navigation objects 324 can be removed from the display.

Global navigation objects 324 may have other attributes according to exemplary embodiments of the present invention, including the number of global navigation objects, their location as a group on the display, their location as individual objects within the group and their effects. Regarding the former attribute, the total number of global navigation objects should be minimized to provide needed short-cut functionality, but without obscuring the primary objectives of the user interface, e.g., access to media items, or overly complicating the interface so that the user can learn the interface and form navigation habits which facilitate quick and easy navigation among the media items. Thus according to various exemplary embodiments of the present invention, the number of global navigation objects 324 provided on any one UI view may be 1, 2, 3, 4, 5, 6 or 7 but preferably not more than 7 global navigation objects will be provided to any given user interface. The previously discussed and illustrated exemplary embodiments illustrate the global navigation objects 324 being generally centered along a horizontal axis of the user interface and proximate a top portion thereof, however other exemplary embodiments of the present invention may render the global navigation objects in other locations, e.g., the upper righthand or lefthand corners of the user interface. Whichever portion of the user interface is designated for display of the global navigation buttons, that portion of the user interface should be reserved for such use, i.e., such that the other UI objects are not selectable within the portion of the user interface which is reserved for the global navigation objects 324.

Additionally, location of individual global navigation objects 324 within the group of global navigation objects, regardless of where the group as a whole is positioned on the display, can be specified based on, e.g., frequency of usage. For example, it may be easier for users to accurately point to global navigation objects 324 at the beginning or end of a row that those global navigation objects in the middle of the row. Thus the global navigation objects 324 which are anticipated to be most frequently used, e.g., the home and live TV global navigation objects in the above-described examples, can be placed at the beginning and end of the row of global navigation objects 324 in the exemplary embodiment of FIG. 4.

According to some exemplary embodiments of the present invention, global navigation objects can have other characteristics regarding their placement throughout the user interface. According to one exemplary embodiment, the entire set of global navigation objects are displayed, at least initially, on each and every UI view which is available in a user interface (albeit the global navigation objects may acquire their non-displayed state on at least some of those UI views as described above). This provides a consistency to the user interface which facilitates navigation through large collections of UI objects. On the other hand, according to other exemplary embodiments, there may be some UI views on which global navigation objects are not displayed at all, such that the user interface as a whole will only have global navigation objects displayed on substantially every UI view in the user interface.

Likewise, it is generally preferable that, for each UI view in which the global navigation objects are displayed, they be displayed in an identical manner, e.g., the same group of global navigation objects, the same images/text/icons used to represent each global navigation function, the same group location, the same order within the group, etc. However there may be some circumstances wherein, for example, the functional nature of the user interface suggests a slight variance to this rule, e.g., wherein one or more global navigation objects are permitted to vary based on a context of the UI view in which it is displayed. For example, for a UI view where direct access to live TV is already available, the live TV global navigation object 406 can be replaced or removed completely. In the above-described exemplary embodiment this can occur when, for example, a user zooms-in on the application entitled “Guide” in FIG. 3(b). This action results in the user interface displaying an electronic program guide, such as that shown in FIG. 10, on the television (or other display device). Note that from the UI view of FIG. 10, a user can directly reach a live TV UI view in a number of different ways, e.g., by positioning a cursor over the scaled down, live video display 1000 and zooming in or by positioning a cursor over a program listing within the grid guide itself and zooming in. Since the user already has direct access to live TV from the UI view of FIG. 10, the live TV global navigation object 406 can be replaced by a DVR global navigation object 1002 which enables a user to have direct access to a DVR UI view. Similarly, the live TV global navigation object 406 for the live TV UI views (e.g., that of FIG. 7) can be replaced by a guide global navigation object which provides the user with a short-cut to the electronic program guide. For those exemplary embodiments of the present invention wherein one or more global navigation objects are permitted to vary from UI view to UI view based on context, it is envisioned that there still will be a subset of the global navigation objects which will be the same for each UI view on which global navigation objects are displayed. In the foregoing examples, a subset of three of the global navigation objects (e.g., those associated with home, up and search functions) are displayed identically (or substantially identically) and provide an identical function on each of the UI views on which they are displayed, while one of the global navigation objects (i.e., the live TV global navigation object) is permitted to change for some UI views.

Still another feature of global navigation objects according to some exemplary embodiments of the present invention is the manner in which they are handled during transition from one UI view to another UI view. For example, as mentioned above some user interfaces according to exemplary embodiments of the present invention employ zooming and/or panning animations to convey a sense of position change within a “Zuiverse” of UI objects as a user navigates between UI views. However, according to some exemplary embodiments of the present invention, the global navigation objects are exempt from these transition effects. That is, the global navigation objects do not zoom, pan or translate and are, instead, fixed in their originally displayed position while the remaining UI objects shift from, e.g., a zoomed-out view to a zoomed-in view. This enables user interfaces to, on the one hand, provide the global navigation objects as visual anchors, while, on the other hand, not detract from conveying the desired sense of movement within the user interface by virtue of having the global navigation buttons in their default watermark (transparent) state.

### Internet Browsers

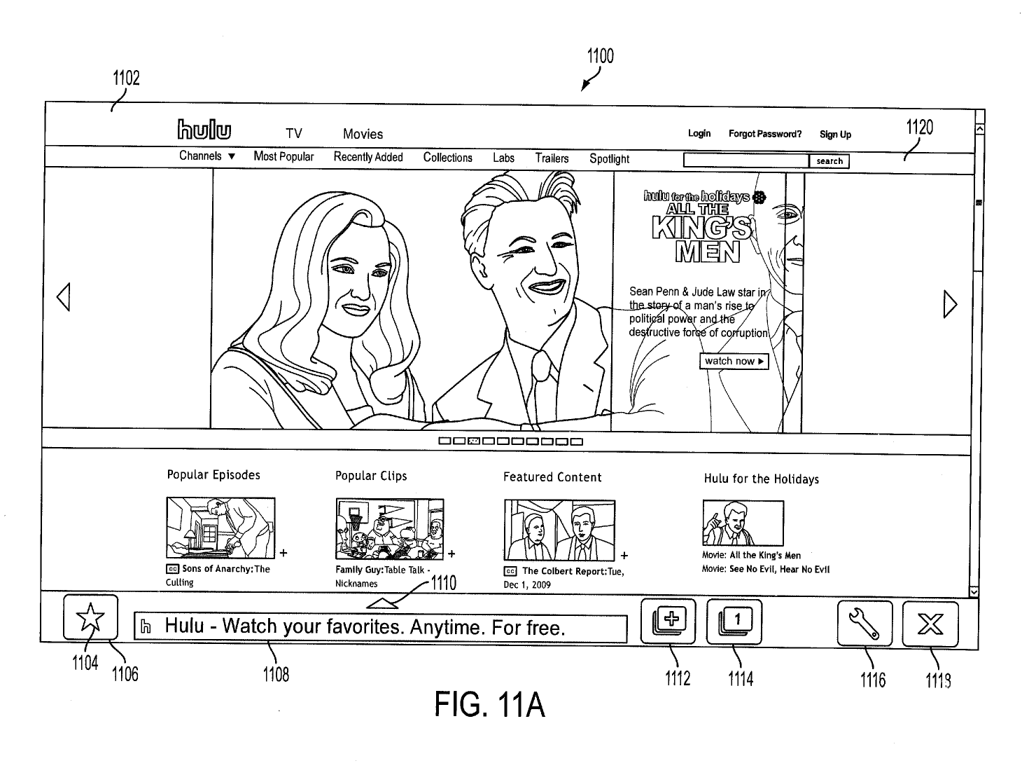

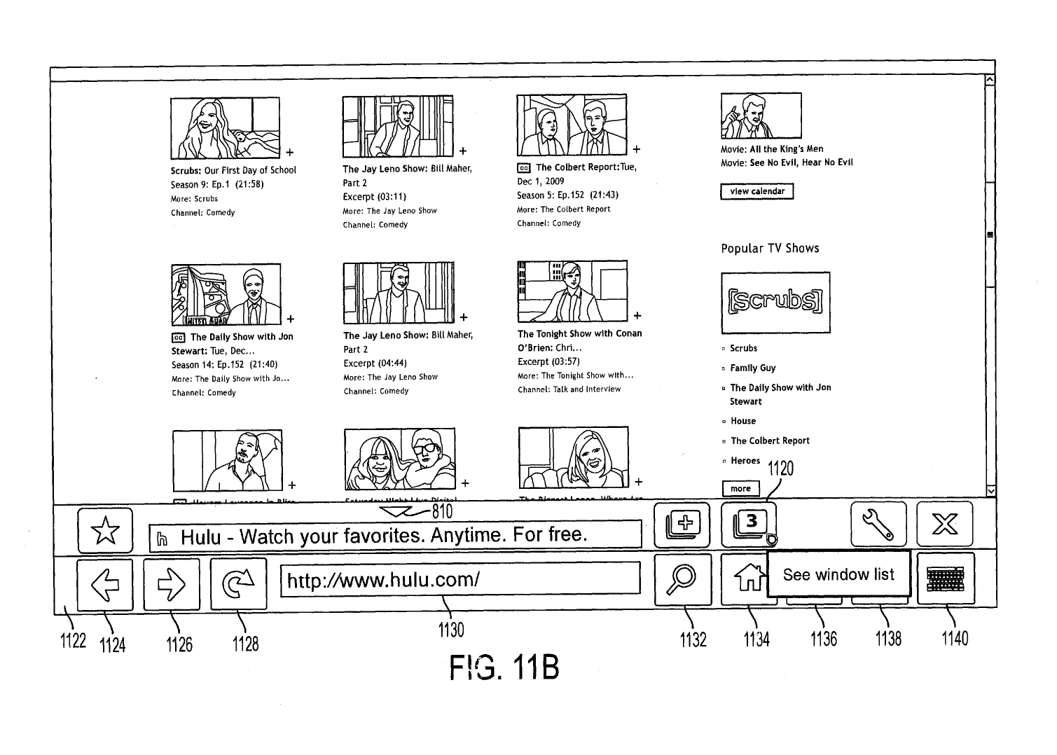

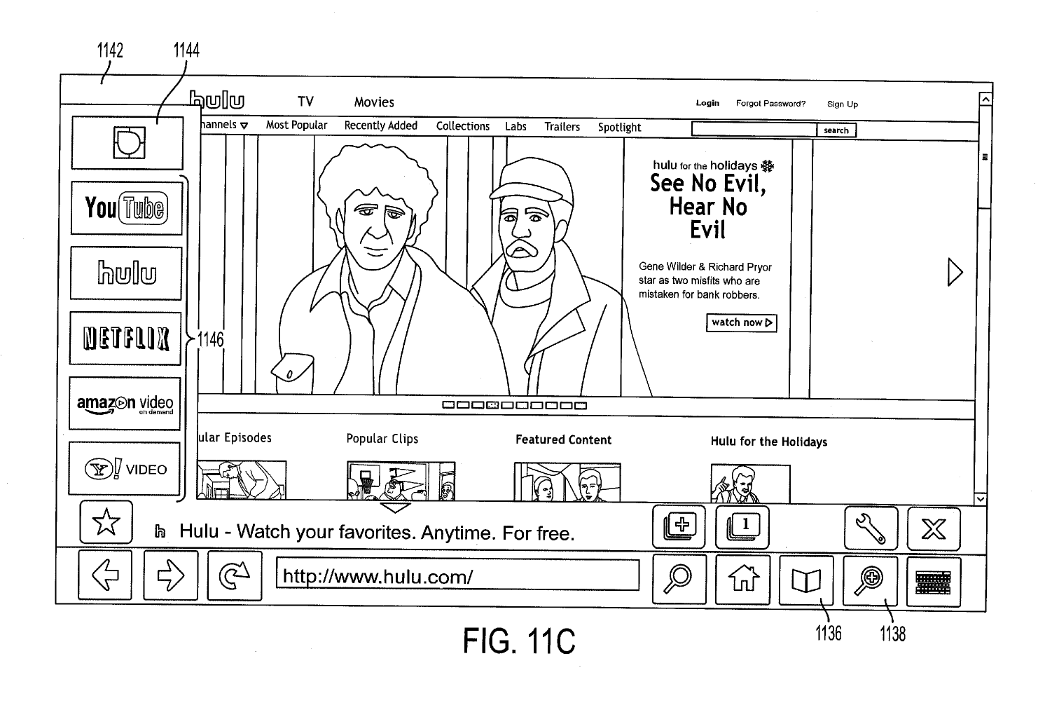

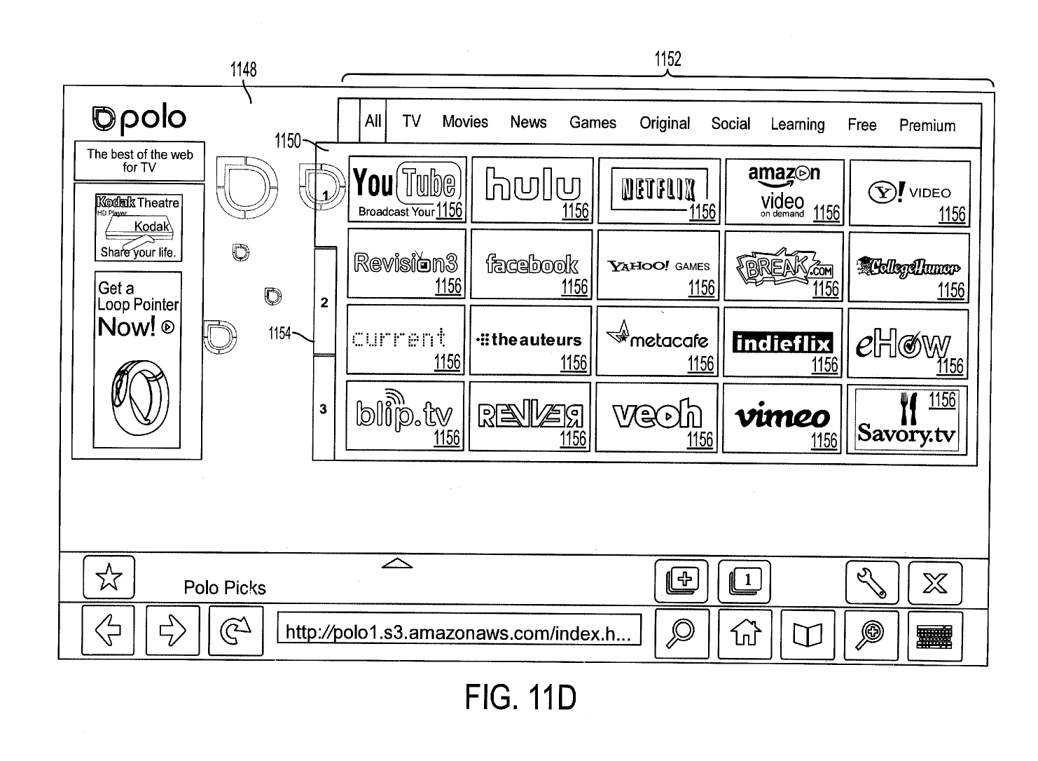

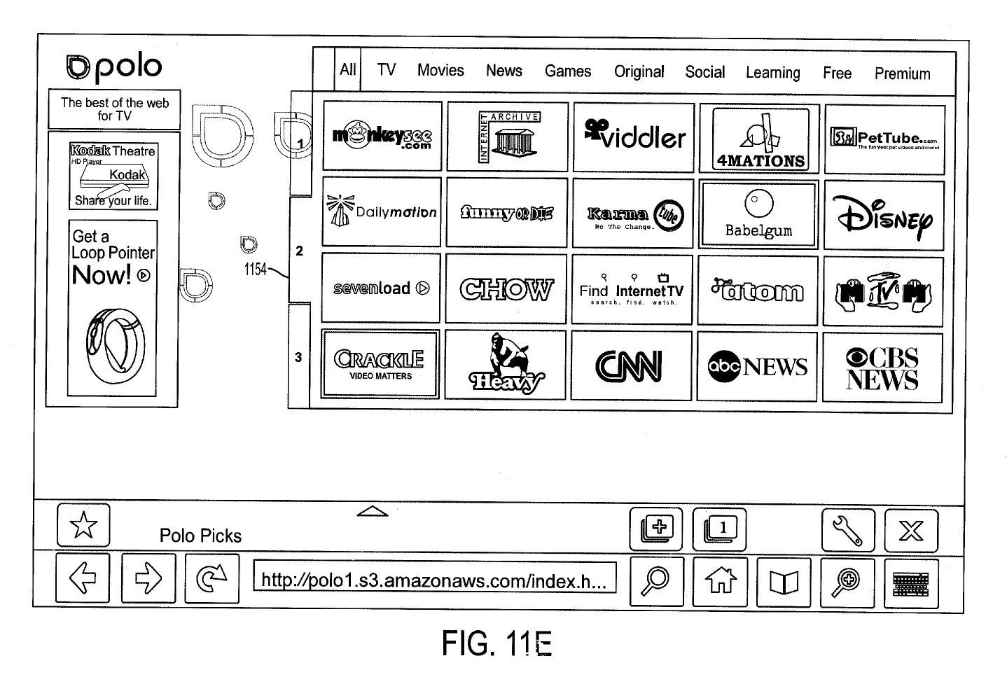

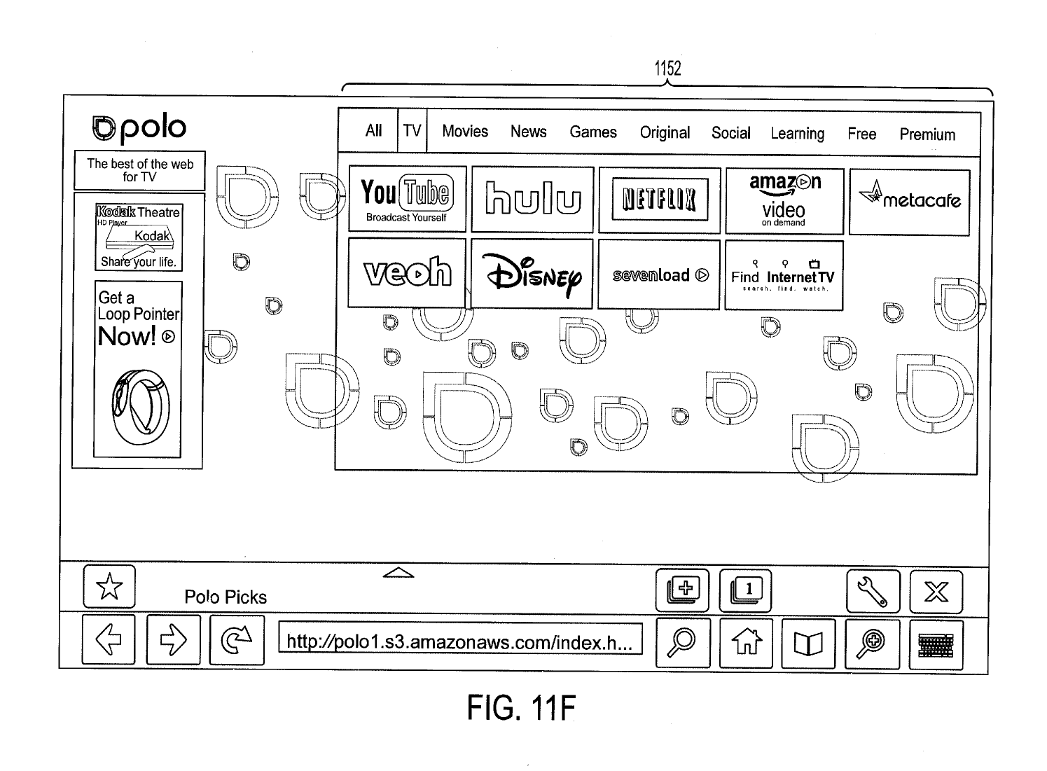

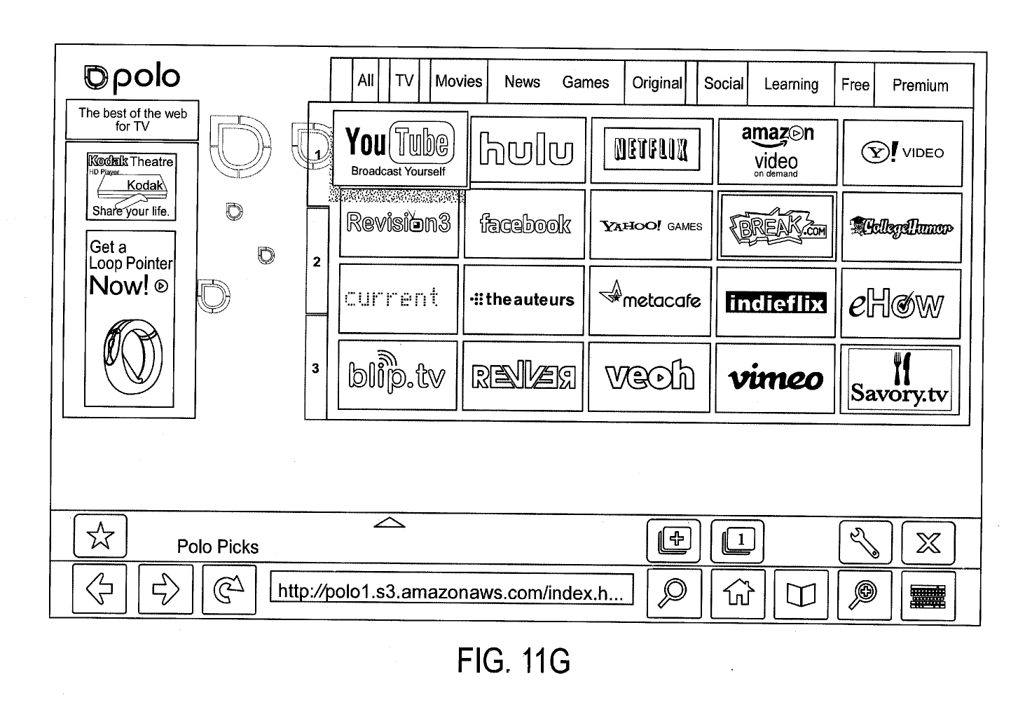

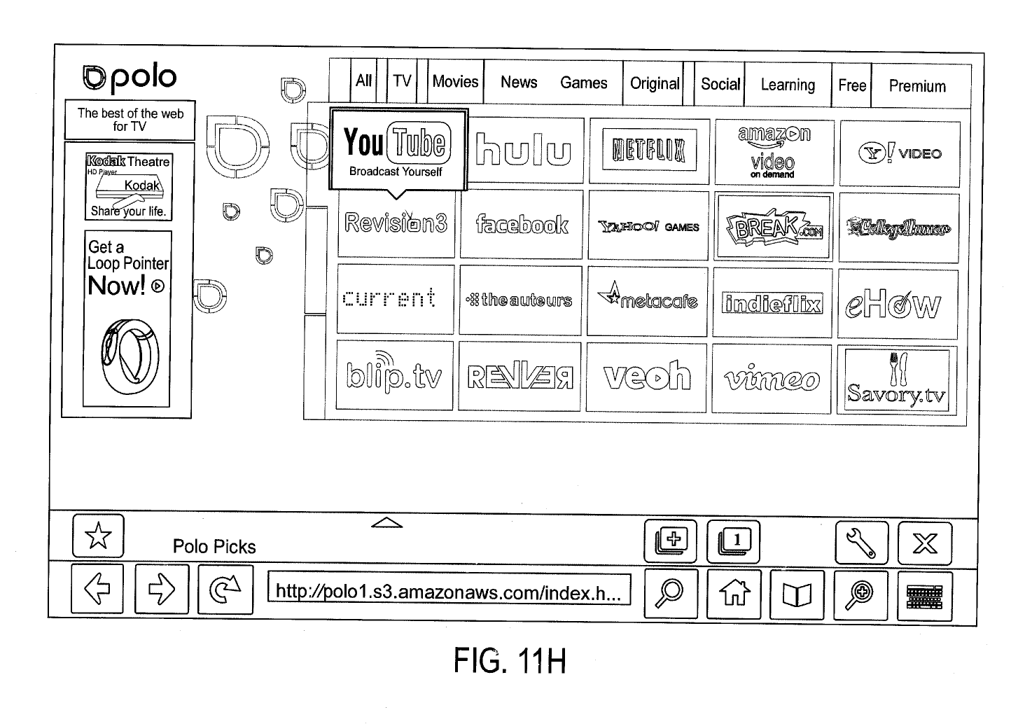

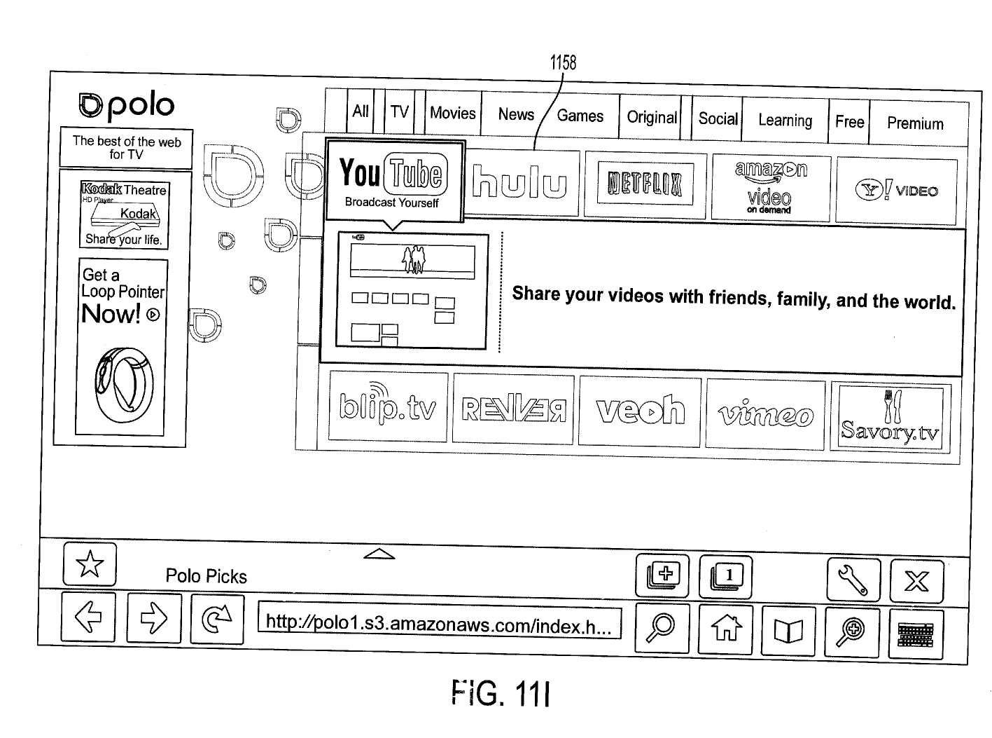

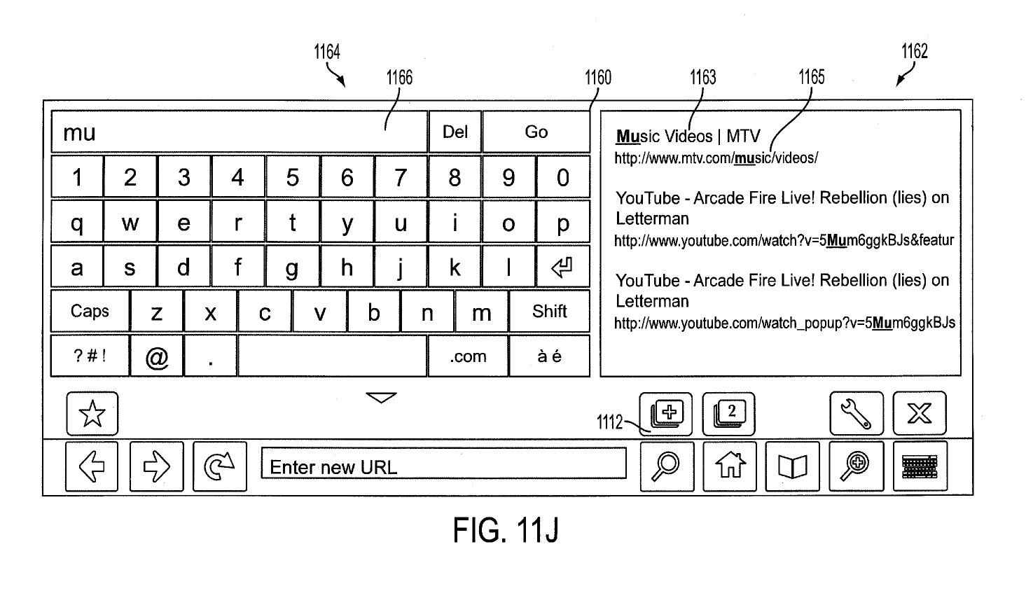

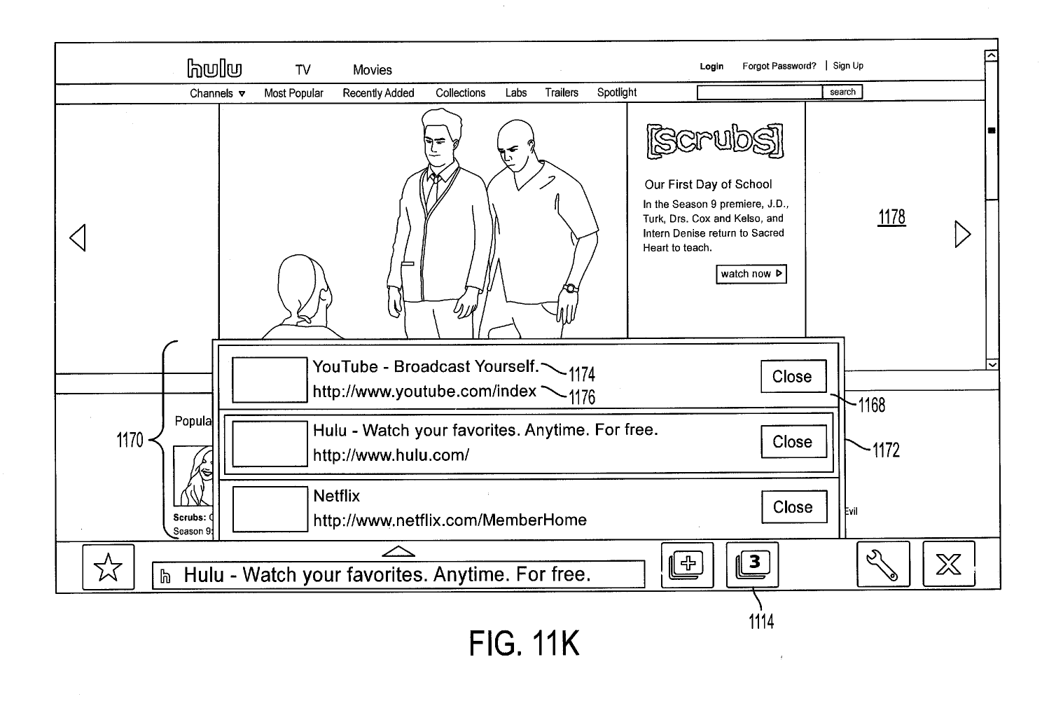

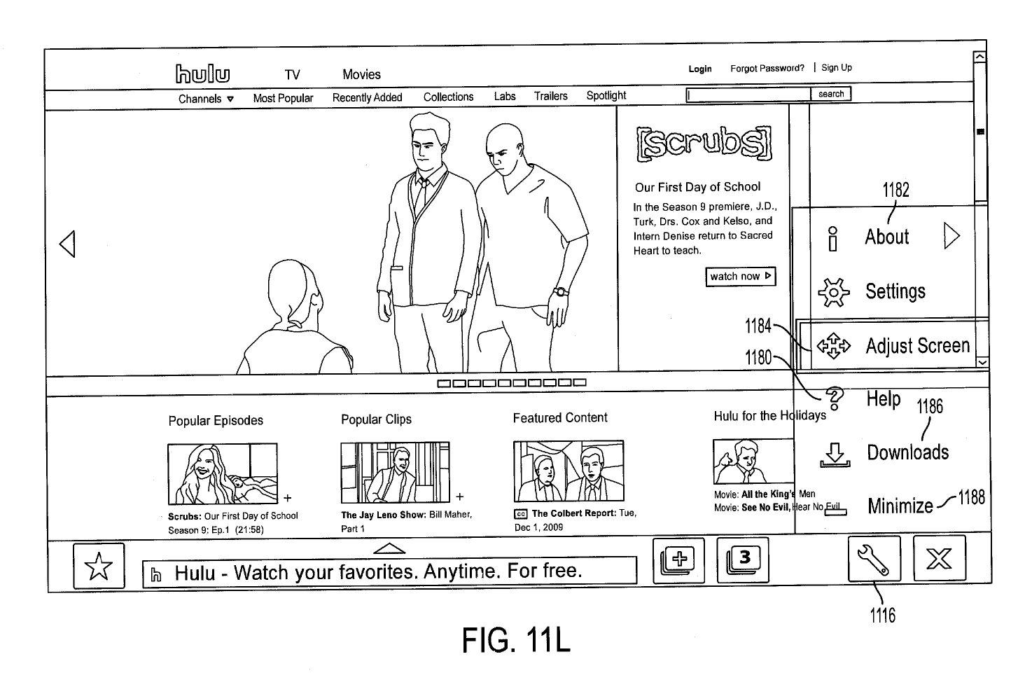

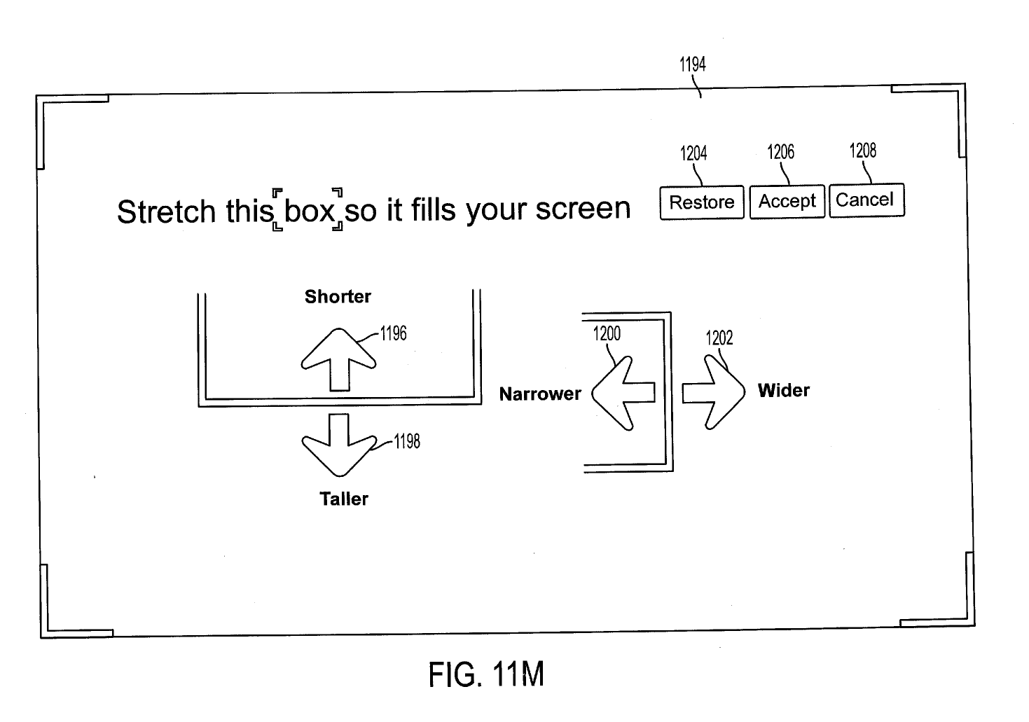

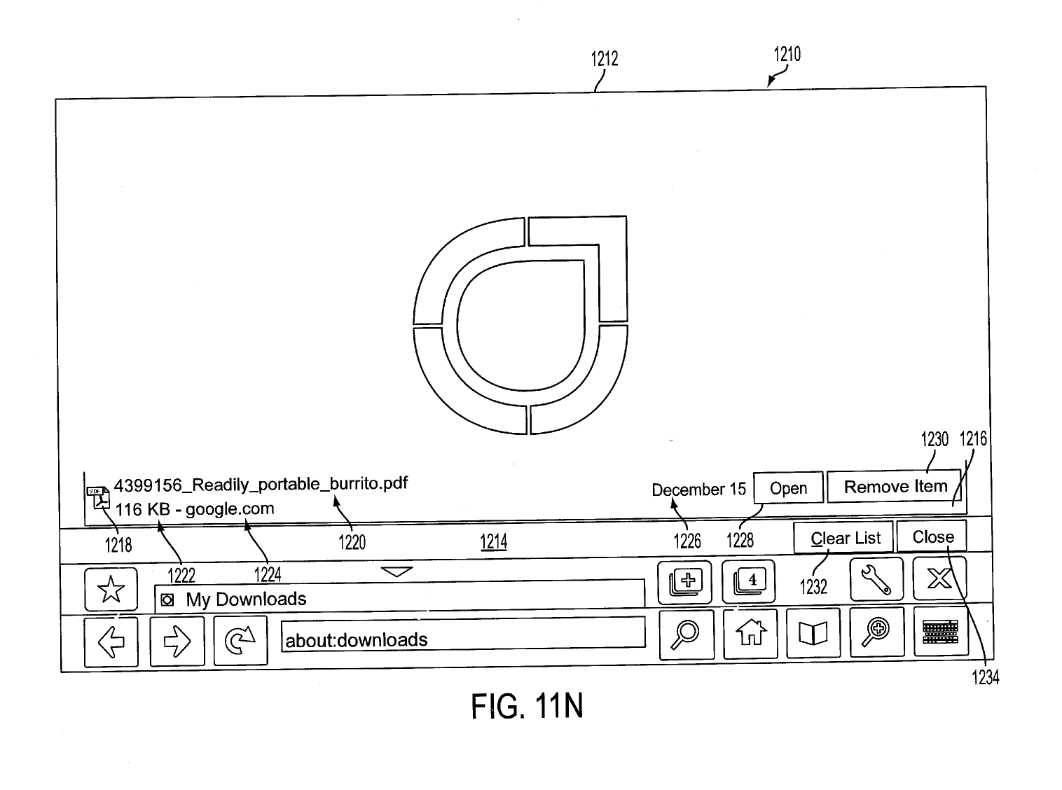

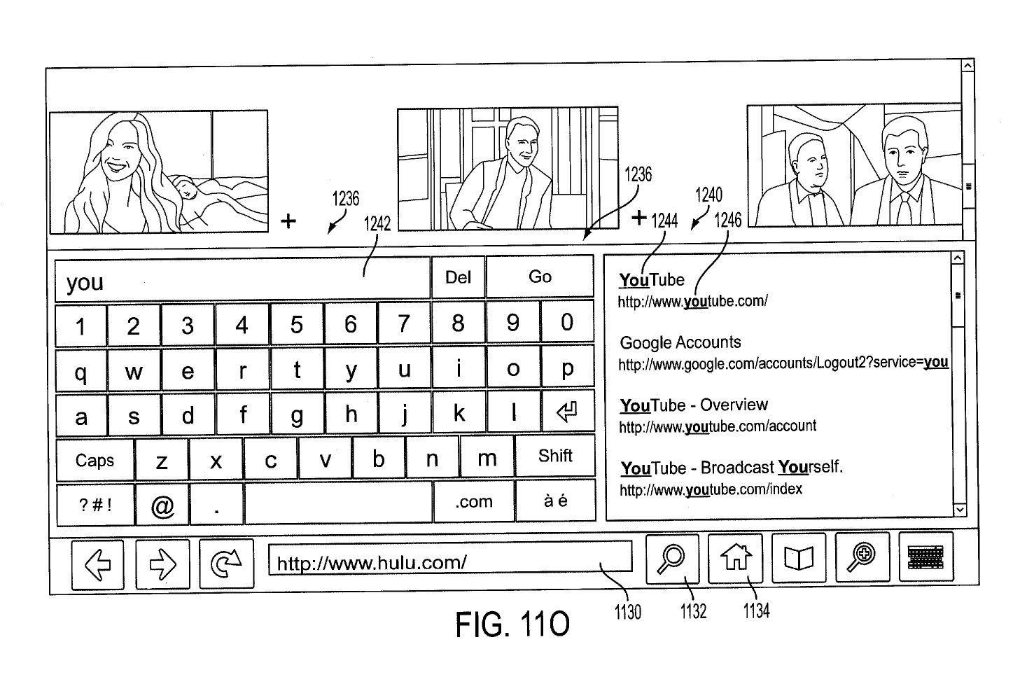

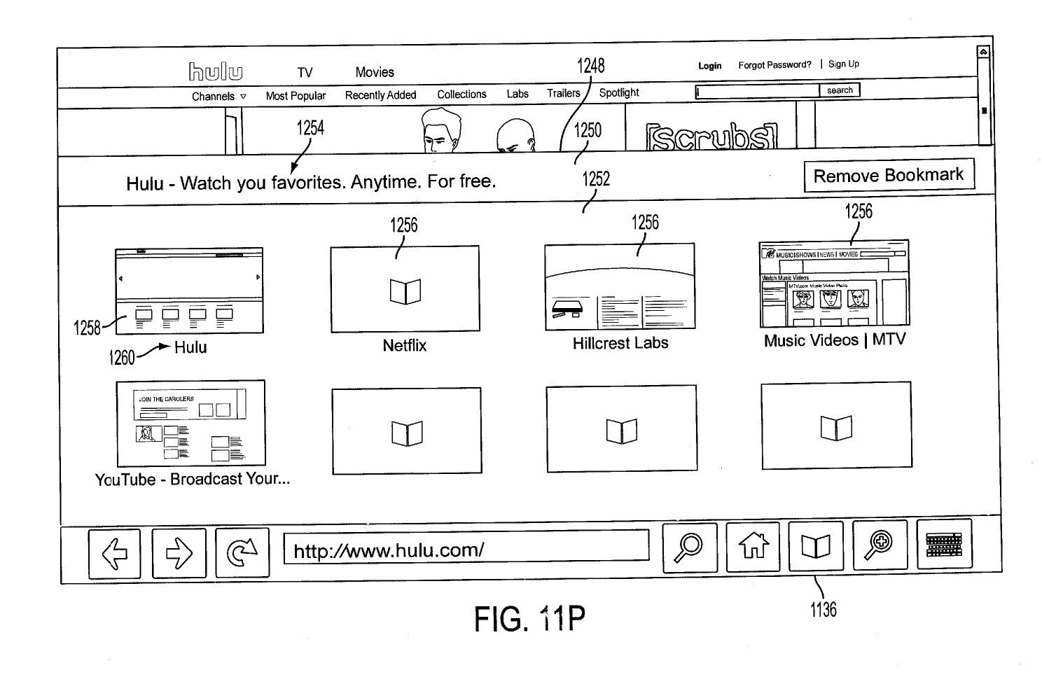

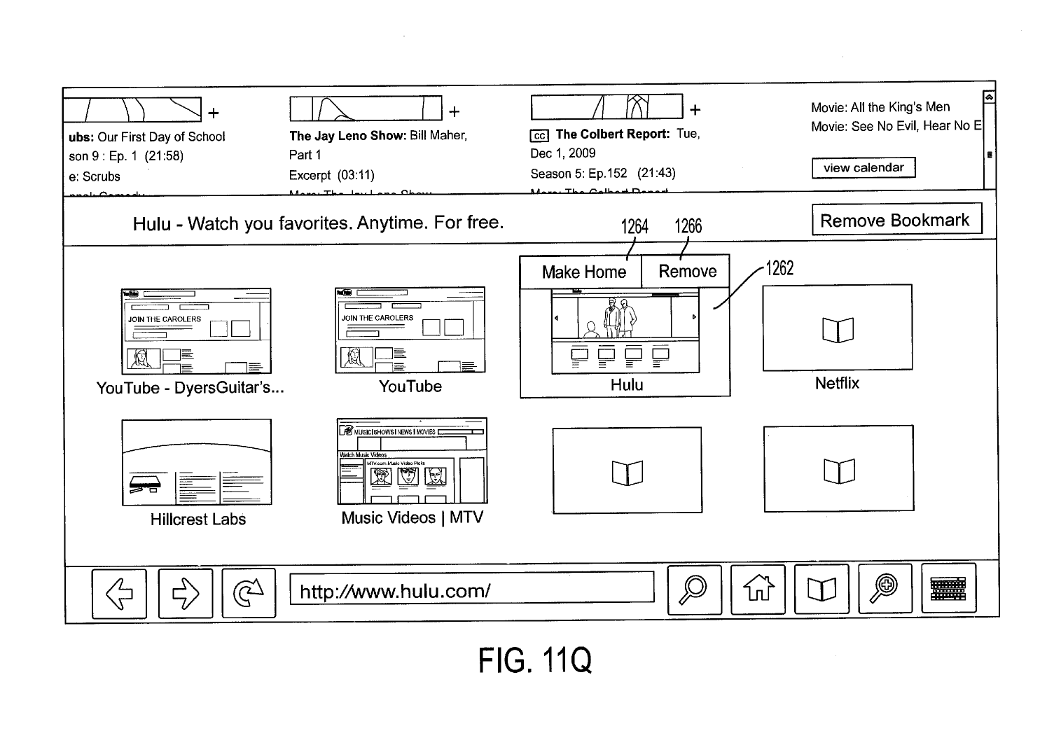

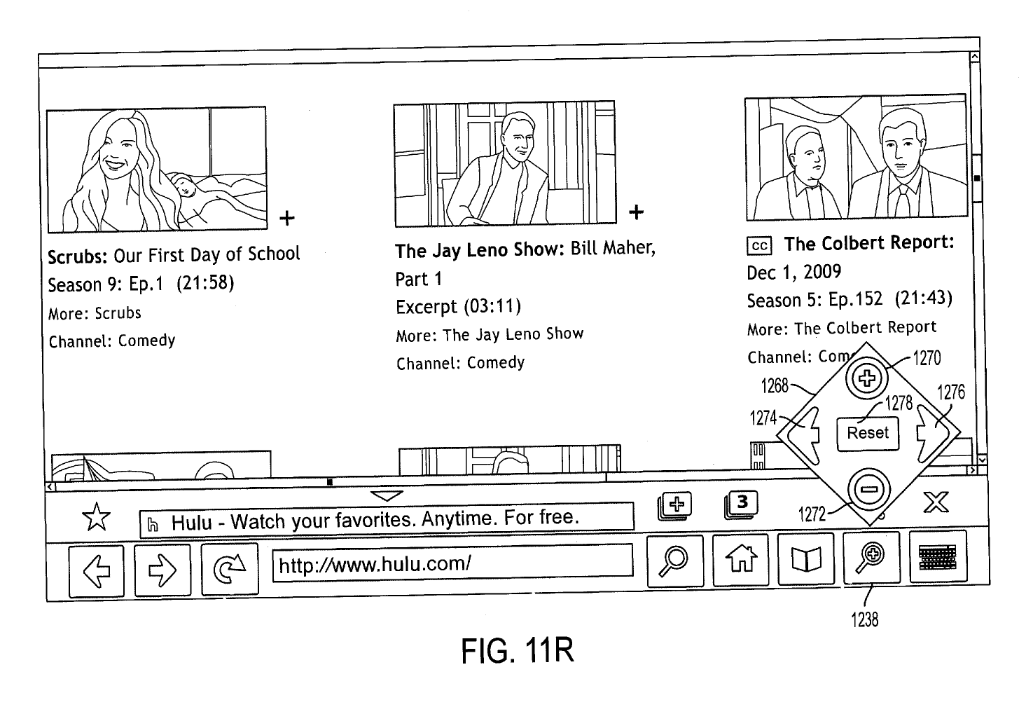

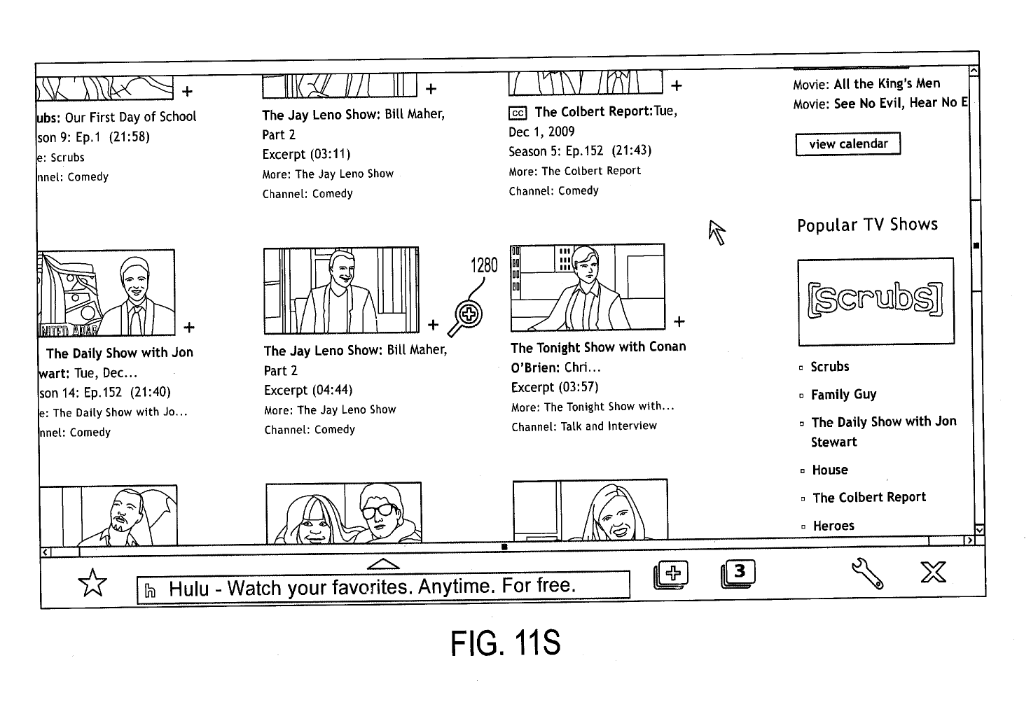

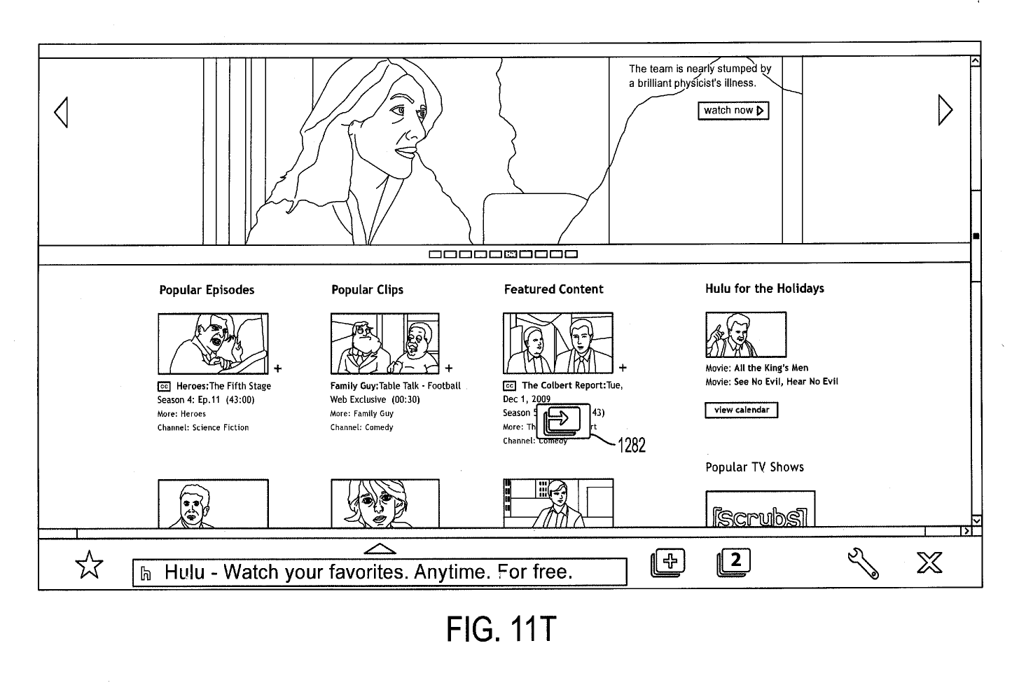

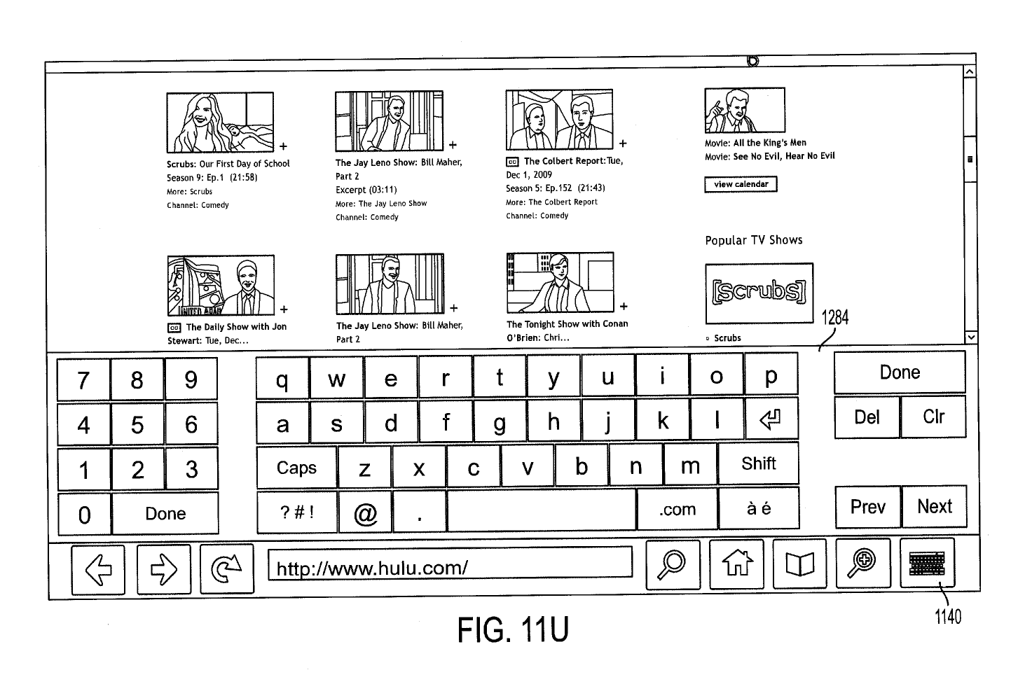

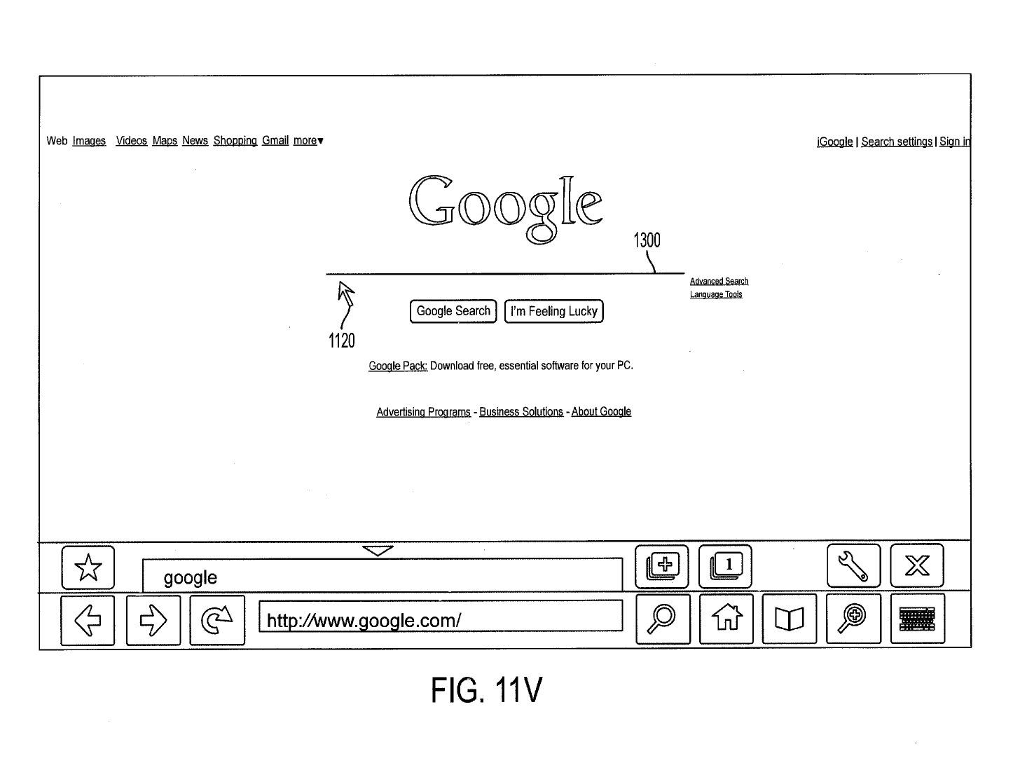

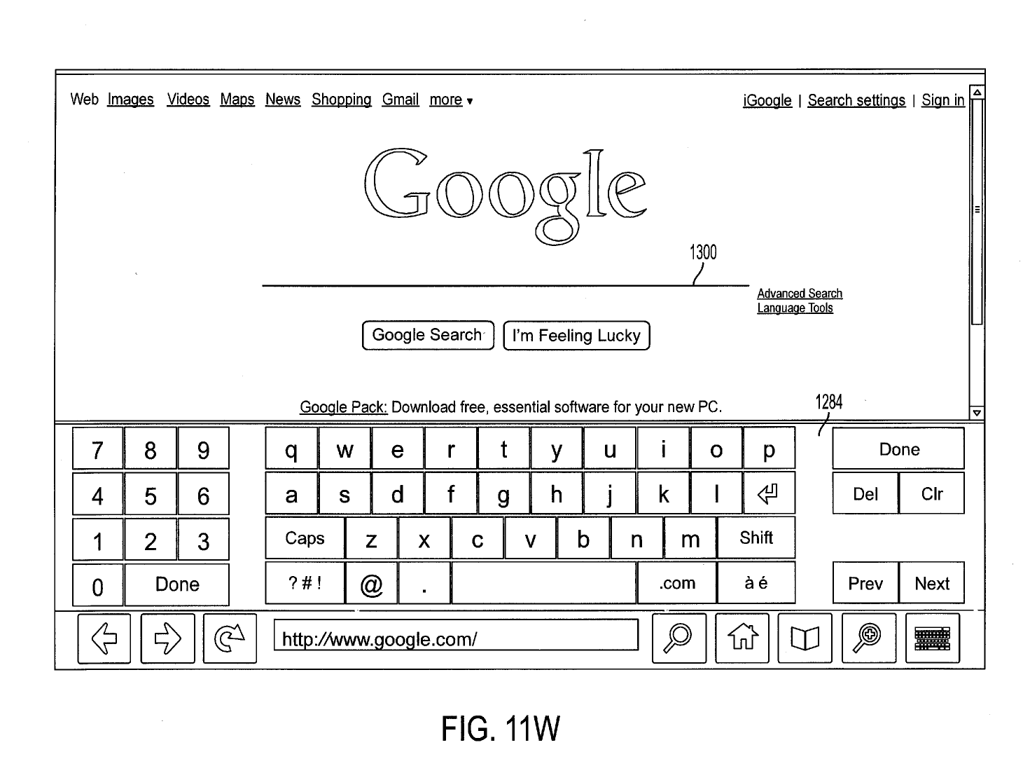

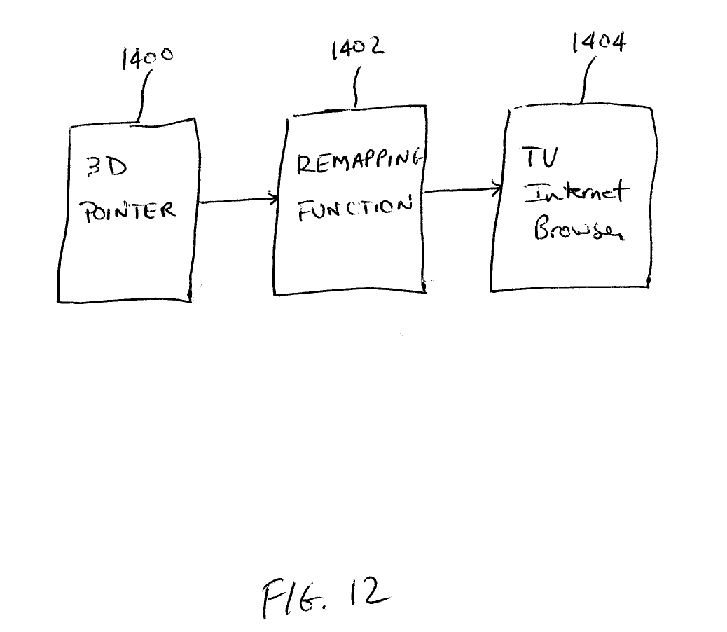

Although not explicitly shown in FIG. 3 (b), applications 322 may also include an Internet browser to permit a user of the system to surf the Web on his or her television. FIGS. 11 (a)-11(w) show an Internet browser 1100 according to an exemplary embodiment of the present invention. Consistent with the above discussion regarding the “10-foot” interface, the Internet browser 1100 is optimized to, for example, enhance the user's experience of the “10-foot” interface by accounting for differences associated with browsing the Internet on a television using a free space pointer from a relatively great distance compared to browsing the Internet on a personal computer using a conventional mouse from a relatively short distance.

Optimization of an Internet browser for the “10-foot” experience according to exemplary embodiments is, at least in some ways, arguably counter intuitive, in that while a much larger display screen may be used for a TV implementation, all of the user interface elements generally need to be displayed with relatively larger proportions than used to display the same or similar user interface elements on a typical computer screen. For example, in this exemplary embodiment, it may be desirable that text is displayed with at least a 24 point font size, and graphics are displayed with a size of at least 60 pixels×60 pixels or at least having one dimension significantly larger than 60 pixels. In addition, it may be desirable for backgrounds of browsers according to exemplary embodiments to be dark and to minimize the amount of screen area used by controls and generally avoid clutter. Further, it may be desirable to optimize the Internet browser 1100 for video display since it is anticipated that users of browsers operating on televisions will view more video content than those using browsers on their personal computers.

As seen in FIG. 11(a), an Internet browser 1100 according to one exemplary embodiment includes two regions on the screen. The first region is a display window 1102 to display content on the screen, e.g. a webpage or video. The second region is an information bar 1104 to display information on the screen and provide access to controls, e.g., buttons that when actuated result in additional actions. It should be noted that the placement of the information bar 1104 relative to display window is contrary to typical Internet browser configurations in which menus may be included above displayed content. This keeps the focus on content displayed in the display window 1102.

In this exemplary embodiment, the information bar 1104 includes a great sites button 1106, a window title display 1108, a show/hide toolbar button 1110, an open new window button 1114, a see window list button 1114, a settings/help button 1116, and an exit button 1118.

A cursor 1120 can be displayed on the screen, having a position controllable via, e.g., the 3D pointing device. A user may position the cursor 1120 over a button and then actuate, e.g., “click”, the control.

The information bar 1104 may, according to exemplary embodiments, be intentionally populated with a minimum number of user interface elements to avoid distracting a user who is watching video or other content on the television. When the user actuates the show/hide toolbar button 1110, the information bar 1104 may be expanded to show a toolbar 1122 (FIG. 11(b)) which displays additional information and provides access to additional controls. For example, in this exemplary embodiment, the toolbar 1122 includes a back button 1124, a forward button 1126, a reload button 1128, an address display/control 1130, a search button 1132, a home button 1134, a bookmarks button 1136, a pan/zoom button 1138, and an onscreen keyboard button 1140.

When the user actuates the great sites button 1106, a great sites menu 1142 (FIG. 11(c)) is displayed. The great sites menu 1142 overlays the display window 1102. The great sites menu 1142 includes controls. For example, in this exemplary embodiment, the great sites menu 1142 includes a portal button 1144 and great sites link buttons 1146. Using this feature, a user can very quickly navigate the browser to point at one of a relatively few sites using image based iconic controls.

When the user actuates the portal button 1144, the display window 1102 displays portal 1148 (FIG. 11(d)). When the user actuates a link button from one of the great sites link buttons 1146, the display window displays the linked content, e.g., the website that is associated with the particular link button. The linked content may be selected based on, for example, content optimized for the “10-foot” interface, paid placement, user preferences, and user actions.

Portal 1148 includes controls. For example, in this exemplary embodiment, portal 1148 includes grid 1150. Grid 1150 includes category buttons 1152, screen buttons 1154, and grid link buttons 1156. Category buttons 1152 list different categories of grid link buttons 1156. Screen buttons 1154 list different screens of grid link buttons 1156, e.g., when there are too many grid link buttons 1156 to fit onto the display area of the grid 1150. Similar to the great sites link buttons 1146, when the user actuates a link button from one of the grid link buttons 1156, the display window displays the linked content, e.g., the website that is associated with the particular link button. In this exemplary embodiment, the category buttons include the categories: “All”, “TV”, “Movies”, “News”, “Games”, “Original”, “Social”, “Learning”, “Free”, and “Premium”. The screen buttons 1154 include numbers indicating the number of grid views available with a particular category. For example, in this exemplary embodiment, there are three screen buttons 1154 associated with the category “All”. Those screen buttons 1154 are labeled “1”, “2”, and “3”.

The operation of grid 1150 is described with reference to FIGS. 11(d)-(i). When the user first enters the portal 1148, grid 1150 is as shown in FIG. 11 (d). The “All” category button 1152 is actuated by default, and all grid link buttons 1156 are displayed. The “All” category button 1152 is highlighted giving a visual indicator to the user that “All” grid link buttons 1156 are displayed, e.g., that the grid link buttons 1156 have not been filtered. However, because more than forty (40) different grid link buttons 1156 are available in the “All” category in this exemplary embodiment, and because only twenty (20) grid link buttons 1156 fit in the display area of the grid 1150, only the first twenty (20) grid link buttons 1156 are displayed in a first grid view. The first grid view is the default grid view and may later be displayed by actuating screen button “1”. The next set of twenty (20) grid link buttons 1156 is displayed in a second grid view. The second grid view is displayed by actuating screen button “2” (FIG. 11(e)). A third grid view may contain the remaining grid link buttons 56 and may be displayed by actuating screen button “3”.

The category buttons 1152 filter grid link buttons 1156 by category. In this exemplary embodiment, the categories are not mutually exclusive relative to one another; however, in other embodiments categories may be mutually exclusive relative to one another. Turning to FIG. 11(f), the “TV” category may be selected by a user by actuating the “TV” category button 1152. When the “TV” category button 1152 is actuated, grid link buttons 1156 are filtered to only display grid link buttons 1156 associated with television.

Selection and actuation of the grid link buttons 1156 is shown in FIGS. 11(g)-11(i). When the cursor 1120 is placed over one of the grid link buttons 1156, a border around that grid link button 1156 is highlighted (FIGS. 11(g) and 11(h)) in a different color and the grid link button 1156 becomes physically enlarged (e.g., via hover zooming) relative to the remaining grid link buttons 1156 such as to bring focus on that particular grid link button. Any category buttons 1152 representing categories that are associated with the particular grid link button 1156 are also highlighted. Turning to an exemplary example, in FIG. 11(g), the cursor 1120 has been placed over the first grid link button in the first row of grid link buttons 1156 causing the border around the first grid link button to be changed from black to blue and the first grid link button to be physically enlarged so as to partially overlap the second grid link button in the first row of grid link buttons 1156. The “All”, “TV”, “Movies”, “Original”, “Social”, and “Free” category buttons 1152 are also highlighted indicating that the first grid link button in the first row of grid link buttons 1156 is associated with the “All”, “TV”, “Movies”, “Original”, “Social”, and “Free” categories.

In addition to the above highlighting of the first grid link button, the remaining grid link buttons 1156 are also “grayed-out” (FIG. 11(h)) relative to the first grid link button. This “graying-out” occurs after a predetermined time period, e.g., 2 seconds, from when the cursor 1120 is first placed over the first grid link button. Thereafter, a grid link information element 1158 (FIG. 11(i) is displayed. The grid link information element 1158 includes information about the linked content, e.g., information describing the website that is associated with the particular link button.

Returning to FIG. 11(a), the information bar 1104 also includes a window title display 1108. The window title display 1108 includes information regarding content displayed in the display window 1102, e.g., the title of a displayed webpage.

The information bar 1104 includes an open new window button 1112. When the user actuates the open new window button 1112, a new display window 1102 instance is displayed, e.g., a blank second window is opened (FIG. 11(j)). Additionally, the open new window toolbar 1160 is displayed. The open new window toolbar 1160 overlays the display window 1102. The open new window toolbar 1160 includes a new window keyboard 1164 and new window links 1162.

The new window keyboard 1164 includes a text entry field 1166. When a user actuates a character on the new window keyboard 1164, e.g., positions the cursor 1120 over the character button and actuates the character button, that character is displayed in the text entry field 1166. The user may repeat this process to enter an address into the text entry field 1166, e.g., enter a URL. When the user actuates the entered address, the open new window toolbar 1160 disappears and the display window 1102, in the new instance or window, displays content associated with the entered address. Because this content associated with the entered address is displayed in the display window 1102 in the second instance, the see window list button 1114 (discussed below) displays the number two (2) indicating to the user that the display window 1102 has available two instances.

In addition to actuating characters on the new window keyboard 1164, the user may also position the cursor 1120 over the text entry field 1166 and actuate the text entry field 1166, e.g., click in the text entry field 1166, and then use another suitable input device to enter text, e.g., use a keypad provided on the 3D pointer device or a physical keyboard, and then actuate the entered address. The user may also use a combination of actuating characters and using another suitable input device to enter and actuate an address.

Each new window link 1162 includes a content title 1163 and a content address 1165. The content title 1163 includes information regarding content capable of being displayed in the display window 1102, e.g., the title of a webpage. The content address 1165 is the address of the content capable of being displayed in the display window 1102, e.g., a URL of a webpage. The new window links 1162 are updated based on input to the text entry field 1166. In this exemplary embodiment, when a user actuates a character, the new window links 1162 may appear and may be populated based on the entered character. For example, if the character “H” is actuated, the new window links 1162 may then appear (where a blank portion first appeared) including a new window link to the Hillcrest Labs website. In addition to actuating characters and using another suitable input device to enter and actuate an address, a user may also position the cursor 1120 over one of the new window links 1162 and actuate that selection. Similar to when the user actuates the entered address, the open new window toolbar 1160 disappears and the display window 1102, in the second instance or window, displays content associated with the actuated link when the user actuates the link. In this manner, the input required of a user to navigate to content displayed in the new instance is minimized relative to fully entering an address into the text entry field 1166.

The information bar 1104 includes a see window list button 1114. When the user actuates the see window list button 1114, a see window (or page) list 1168 (FIG. 11(k)) is displayed. The see window list 1168 overlays the display window 1102. The see window list 1168 includes instance selections 1170 associated with opened instances or windows that may be displayed in the display window 1102. It should be noted that, as more fully discussed below, the see window list 1168 differs from the tabs implementation in typical browsers in that actual tabs are not displayed. This is consistent with the “10-foot” interface in that it prevents small and unreadable tabs, and the shrinking of a content display area. Instead, the user is presented with visually appealing similarly sized instance selections 1170.

Each instance selection 1170 includes a screen shot 1172, a content title 1174, a content address 1176, and a close button 1178. The screen shot 1172 is a screen shot of the content shown in that instance of the display window 1102. The content title 1174 includes information regarding content displayed in the particular instance displayed in the display window 1102, e.g., the title of a displayed webpage. The content address 1176 is the address of the content displayed in the particular instance displayed in the display window 1102, e.g., the URL of a displayed webpage.

The see window list 1168 is capable of displaying a predetermined number of instance selections 1170, e.g., the see window list 1168 has a predetermined size. Because the number of instance selections 1170 may exceed the predetermined number of instance selections capable of being displayed on the window list 1168, a scroll bar may be provided on the side of the see window list 1168.

The user may position the cursor 1120 over one of the instance selections 1170 and actuate an instance selection 1170. When the user actuates an instance selection 1170, the see window list 1168 disappears and the display window 1102 displays the instance associated with the actuated instance selection 1170.

The user may position the cursor 1120 over the close button 1178 of a particular instance selection 1170 and actuate the close button 1178. When the user actuates the close button 1178, the instance selection 1170 is removed from the window list 1168 and the particular instance associated with the removed instance selection 1170 is no longer available for display in the display window 1102. Because an instance is removed, the see window list button 1114 displays an updated number indicating to the user that the display window 1102 has available the updated number of instances. The user may position the cursor 1120 over the see window list button 1114 and actuate the see window list button 1114. When the user actuates the see window list button 1114, the see window list 1168 is closed.

The information bar 1104 includes a settings/help button 1116. When the user actuates the settings/help button 1116, a settings/help menu 1180 is displayed as seen in FIG. 11(l). The settings/help menu 1180 overlays the display window 1102. The settings/help menu 1180 includes controls. For example, in this exemplary embodiment, settings/help menu 1180 includes an about button 1182, a settings button, an adjust screen button 1184, a help button, a downloads button 1186, and a minimize button 1188.

When a user actuates the about button 1182, the display window 1102 displays an about screen. The about screen may contain information about the Internet browser and a close button. When the user actuates the close button, the about screen may disappear. Similarly, the settings button and help button may contain information and controls. The display window 1102 may display a settings screen and help screen upon actuation of the settings button and help button, respectively.

When a user actuates the adjust screen button 1184, an adjust screen tool 1194 (FIG. 11(m)) is displayed. The adjust screen tool 1194 completely fills the screen, e.g., both the display window 1102 and the information bar 1104 are replaced by the adjust screen tool 1194. The adjust screen tool 1194 includes controls. The controls adjust the display area of the Internet browser 100 on the screen. In this exemplary embodiment, the adjust screen tool 1194 includes a shorter button 1196, a taller button 1198, a narrower button 1200, a wider button 1202, a restore button 1204, an accept button 1206, and a cancel button 1208. Inward or outward toward/from a vertical center of the screen, the shorter button 1196 and taller button 1198 decrease (e.g., by adding blank padding) and increase (e.g., by removing blank padding) the display area on the screen, respectively. Inward or outward toward/from a horizontal center of the screen, the narrower button 1200 and the wider button 1202 decrease and increase the display area on the screen, respectively. The restore button 1204 restores settings controllable by the shorter, taller, narrower, and wider buttons 1196, 1198, 1200, 1202 to a default configuration. The accept button 1206 accepts settings selected by the user. The cancel button 1208 closes the adjust screen tool 1194.

The user may position the cursor 1120 over the shorter or taller buttons 1196, 1198 and actuate one or the other button. When the user actuates the shorter button 1196, the screen area is decreased inward toward a vertical center of the screen, e.g., the display area of the Internet browser is made shorter by bringing in the top and bottom of the display area toward the vertical center. When the user actuates the taller button 1198, the screen area is increased outward from the vertical center of the screen, e.g., the display area of the Internet browser is made taller by pushing out the top and bottom of the display area from the vertical center. When the user actuates the narrower button 1200, the screen area is decreased inward toward a horizontal center of the screen, e.g., the display area of the Internet browser is made narrower by bringing in the left and right of the display area toward the horizontal center. When the user actuates the wider button 1202, the screen area is increased outward from the horizontal center of the screen, e.g., the display are of the Internet browser is made wider by pushing out the left and right of the display area from the horizontal center. In each of these cases, actuation may be repeated as desired, e.g., the user may actuate, for example, the shorter button to again increase the display are on the screen. Repeating may be accomplished by repeated actuation or by continue actuation over a predetermined period of time.

Once the user is satisfied with the display area of the Internet browser 1100 on the screen, the cursor 1120 may be positioned over the accept button 1206, and the accept button 1206 may be actuated. When the accept button 1206 is actuated, the display area of the Internet browser is stored, and the adjust screen tool 1194 is closed. The cursor 1120 may be positioned over the restore button 1204, and the restore button 1204 may be actuated. When the restore button 1204 is actuated, settings controllable by the shorter, taller, narrower, and wider buttons 1196, 1198, 1200, 1202 are restored to a default configuration, e.g., the settings are reset to an initial configuration. The cursor 1102 may be positioned over the cancel button 1208, and the cancel button 1208 may be actuated. When the cancel button 1208 is actuated, the adjust screen tool 1194 is closed.

When a user actuates the downloads button 1186, the display window 1102 displays a downloads screen 1210 (FIG. 11(n)). The downloads screen 1210 includes a list portion 1212 and a downloads toolbar 1214. The list portion 1212 includes downloads selections 1216 associated with files downloaded by the Internet browser 1100.

Each downloads selection 1216 includes a download icon 1218, a download title 1220, a download size 1222, a download source 1224, a download date 1226, an open button 1228, and a remove item button 1230. The download icon 1218 is a graphic icon indicating the type of file associated with the download selection 1216. The download title 1220 includes information regarding the file associated with the download selection 1216, e.g., the title of the download. The download size 1222 includes the size of the file associated with the download selection 1216. The download source 1224 includes the source of the file associated with the download selection 1216. The download date 1226 includes the date the Internet browser 1100 downloaded the file associated with the down selection 1216.

The user may position the cursor 1120 over one of the downloads selections 1216 an actuate a download selection 1216. For example, in this exemplary embodiment, the cursor 1120 may be placed over the download selection 1216 and may “double click” the 3D input device to launch the downloaded file. The cursor may also be placed over the open button 1228 and the open button may be actuated to launch the downloaded file.

The user may position the cursor 1120 over the remove item button 1230 of a particular download selection 1216 and actuate the remove item button 1230 may be actuated. When the remove item button 1230 is actuated, the download selection 1216 may be removed from the downloads list portion 1212, and the particular file associated with the download selection 1216 may be removed.

The downloads screen 1210 includes the download toolbar 1214 which includes a clear list button 1232 and a close button 1234. The user may position the cursor 1120 over the clear list button 1232 and actuate the clear list button 1232. When the user actuates the clear list button 1232, all download selections 1216 in the downloads list portion 1212 may be removed from the downloads list portion 1212, and the files associated with the downloads selections may be removed. The user may position the cursor 1120 over the close button 1234 and actuate the close button 1234. When the user actuates the close button 1234, the downloads screen 1210 is closed.

The settings/help menu 1180 includes a minimize button 1188. A user may position the cursor 1120 over the minimize button 1188 and actuate the minimize button 1188. When a user actuates the minimize button 1188, the Internet browser 1100 may be minimized, e.g., no longer displayed on the screen.

The information bar 1104 includes an exit button 1118. A user may position the cursor 1120 over the exit button and actuate the exit button 1118. When a user actuates the exit button 1118, the Internet browser 1100 may be closed, e.g., shutdown.

The toolbar 1122 includes back button 1124, a forward button 1126, and a reload button 1128. A user may position the cursor 1120 over the back, forward or reload button 1124, 1126, 1128, and actuate either the back, forward or reload button. Upon actuation of the back button 1124, the display window 1102 displays content displayed immediately previous to the currently displayed content, e.g., navigate back to a webpage displayed immediately before the currently displayed webpage. If no content was previously displayed, e.g., the Internet browser 1100 was just opened and no previous history exists, no action may be performed upon actuation of the back button 1124. Additionally, a user may use an input on the 3D pointer device (e.g., a “right click”) as a shortcut to navigate back. Upon actuation of the forward button 1126, the display window 1102 displays content displayed immediately after the currently displayed content, e.g., navigate forward to a webpage displayed immediately after the currently displayed webpage. If no content was displayed after the currently displayed content, e.g., the back button 1124 has not been used to navigate back from another website, no action may be performed upon actuation of the forward button 1126. Upon actuation of the reload button, 1128, the display window 1102 may reload the currently displayed content, e.g., refresh a currently displayed webpage.

The information bar includes an address display/control 1130 as shown in FIG. 11(o). The address display/control 1130 includes an address of the content displayed in the display window 1102, e.g., a URL of a displayed webpage. Additionally, the cursor 1120 may be positioned over the address display/control 1130 and the address display/control 1130 may be actuated. When the address display/control 1130 is actuated, an address toolbar 1236 is displayed. The address toolbar 1236 overlays the display window 1102. The address toolbar 1236 includes a keyboard 1238 and links 1240.

The keyboard 1238 includes a text entry field 1242. When a user actuates a character on the keyboard 1238, e.g., positions the cursor 1120 over the character button and actuates the character button, that character is displayed in the text entry field 1242. The user may repeat this process to enter an address into the text entry field 1242, e.g., enter a URL. When the user actuates the entered address, the address toolbar 1236 disappears and the display window 1102, in the current instance or window, displays content associated with the entered address.

In addition to actuating characters on the keyboard 1238, the user may also position the cursor 1120 over the text entry field 1242 and actuate the text entry field 1242, e.g., click in the text entry field 1242, and then use another suitable input device to enter text, e.g., use a keypad provided on the 3D pointer device or a physical keyboard, and then actuate the entered address. The user may also use a combination of actuating characters and using another suitable input device to enter and actuate an address.

Each link 1240 includes a content title 1244 and a content address 1246. The content title 1244 includes information regarding content capable of being displayed in the display window 1102, e.g., the title of a webpage. The content address 1246 is the address of the content capable of being displayed in the display window 1102, e.g., a URL of a webpage. The links 1240 are updated based on input to the text entry field 1242. In this exemplary embodiment, when a user actuates a character, the links 1240 may appear and may be populated based on the entered character. For example, if the character “H” is actuated, the links 1240 may then appear (where a blank portion first appeared) including a link to the Hillcrest Labs website. In addition to actuating characters and using another suitable input device to enter and actuate an address, a user may also position the cursor 1120 over one of the links 1240 and actuate that link. Similar to when the user actuates the entered address, the address toolbar 1236 disappears and the display window 1102, in the current instance or window, displays content associated with the actuated link when the user actuates the link. In this manner, the input required of a user to navigate to content is minimized relative to fully entering an address into the text entry field 1242.

The toolbar 1122 includes a search button 1132. A user may position the cursor 1120 over the search button 1132 and actuate the search button 1132. When the user actuates the search button 1132, the display window 1102 displays search content, e.g., a search engine website that is associated with the search button 1132. The search content may be optimized for the “10-foot” interface, and may be focused on retrieving video content.

The toolbar 1122 includes a home button 1134. A user may position the cursor 1120 over the home button 1134 and actuate the home button 1134. When the user actuates the home button 1134, the display window 1102 displays a default content, e.g., a home webpage that is associated with the home button 1134.

The toolbar 1122 includes a bookmarks button 1136. A user may position the cursor 1120 over the bookmarks button 1136 and the bookmarks button 1136 may be actuated. When the user actuates the bookmarks button 1136, a bookmarks directory 1248 (FIG. 11(p)) is displayed. The bookmarks directory 1248 is a spatial directory of bookmarks (instead of a more typical list). The bookmarks directory 1248 overlays the display window 1102. The bookmarks directory 1248 includes an action toolbar 1250 and a bookmarks grid 1252.

The action toolbar 1250 includes a content title 1254 and an action button 1256. The content title display 1254 includes information regarding content displayed in the display window 1102, e.g., the title of a displayed webpage. In this exemplary embodiment, the action button 1256 may take one of two actions depending on whether the content displayed in the display window 1102 is already bookmarked. If the content displayed in the display window 1102 is already bookmarked, the action button 1256 may read remove bookmark. If the content displayed in the display window 1102 is not already bookmarked, the action button 1256 may read make bookmark. The user may position the cursor 1120 over the action button 1256 and actuate the action button 1256. Upon actuation of the action button 1256, the already existing bookmark button 1256 may be removed if the content is already bookmarked, or a bookmark button 1256 may be added if the content is not already bookmarked.

The bookmarks grid 1252 includes bookmark buttons 1256. The display area of the bookmarks grid 1252 may depend on the number of bookmark buttons 1256. For example, in this exemplary embodiment, the bookmarks grid may be capable of displaying four bookmark buttons 1256 side by side. Accordingly, if one to four bookmark buttons 1256 are available, the bookmarks grid 1252 may be a 1×4 grid. Accordingly, the bookmarks directory 1248 overlays a portion of the display window 1102. If five to eight bookmark buttons are available, the bookmarks grid 1252 may be a 2×4 grid. Accordingly, the bookmarks directory 1248 may overlay a larger portion of the display window 1102. With enough bookmark buttons 1256, the bookmarks directory 1248 may completely overlay the display window 1202. Because the number of bookmark buttons 1256 may exceed a predetermined number of bookmark buttons 1256 capable of being displayed on the bookmarks grid 1252, a scroll bar may be provided on the side of the bookmarks grid 1252.

Each bookmark button 1256 includes a screen shot 1258 and a content title 1260. The screen shot 1258 is a screen shot of the content associated with the particular bookmark button 1256. The screen shot 1258 may be captured on the fly, e.g., during a loading operation of the content in the display window 1102. The content title 1260 includes information regarding the content associated with the particular bookmark button 1256, e.g., a title of the bookmarked webpage.

The operation of the bookmark buttons 1256 is described with reference to FIG. 11(q). A user may position the cursor 1120 over one of the bookmark buttons 1256. Upon positioning the cursor 1120 over one of the bookmark buttons 1256, a bookmark button frame 1262 is displayed. In addition to the screen shot 1258 and the content title 1260 (which may be contrasted upon display of the bookmark button frame 1262), the bookmark button frame 1262 includes additional bookmark button 1256 items, e.g., context sensitive selections. For example, in this exemplary embodiment, the bookmark button frame 1262 includes a make home button 1264 and a remove button 1266. The user may position the cursor 1120 over the make home button 1264 and actuate the make home button 1264. Upon actuation of the make home button 1264, the content associated with the particular bookmark button 1256 may be designated as the default content to be displayed when the home button 1134 is actuated, e.g., the bookmarked webpage becomes the home webpage. The user may position the cursor 1120 over the remove button 1266 and actuate the remove button 1266. Upon actuation of the remove button 1266, the bookmark button 1256 may be removed, e.g., the bookmark removed.

The toolbar 1122 includes a pan/zoom button 1138. The user may position the cursor 1120 over the pan/zoom button 1138 and actuate the pan/zoom button 1138. Upon actuation of the pan/zoom button 1138, a pan/zoom mechanism 1268 (FIG. 11(r)) may be displayed. The pan/zoom mechanism 1268 overlays the display window. The pan/zoom mechanism 1268 is partially transparent relative to the content displayed in the display window 1102. The pan/zoom mechanism 1268 includes controls. For example, in this exemplary embodiment, the pan/zoom mechanism includes a zoom-in button 1270, a zoom-out button 1272, a pan-left button 1274, a pan-right button 1276, and a reset button 1278.

The operation of the pan/zoom mechanism is discussed with reference to FIGS. 11(r)-(t). When the user first launches the pan/zoom mechanism 1268, the content currently displayed in the display window 1102 is at a default zoom level, e.g., items on the website have not been increased in size or made smaller in size and at a default pan position, e.g., the website is at a center. This default zoom level and default pan position may be restored by positioning the cursor 1120 over the reset button 1278 and actuating the reset button 1278.

The user may position the cursor 1120 over the zoom-in button 1270 and actuate the zoom-in button 1270. Upon actuation of the zoom-in button 1270, the content currently displayed in the display window 1102 is made larger, e.g., the items on the website such as text and graphic files are made larger. It should be noted that all items of content are made larger while preserving their size relative to one another. This preserves the intended design appearance of the content. In FIG. 11(r), the content in the display window 1102 has been made larger (i.e., the website has been zoomed-in) relative to FIG. 11(s).

The user may position the cursor 1120 over the zoom-out button 1272 and actuate the zoom-out button 1272. Upon actuation of the zoom-out button 1272, the content currently displayed in the display window 1102 is made smaller, e.g., the items on the website such as text and graphic files are made smaller. It should be noted that all items of content are made smaller while preserving their size relative to one another. This preserves the intended design appearance of the content. In FIG. 11(s), the content in the display window 1102 has been made smaller (i.e., the website has been zoomed-out) relative to FIG. 11(r).

The user may position the cursor 1120 over the pan-left button 1274 and actuate the pan-left button 1274. Upon actuation of the pan-left button 1274, the content currently displayed in the display window 1102 is moved to the right, e.g., the view of the website pans left, if content is available to the left.

The user may position the cursor 1120 over the pan-right button 1276 and actuate the pan-right button 1276. Upon actuation of the pan-right button 1276, the content currently displayed in the display window 1102 is moved to the left, e.g., the view of the website pans right, if content is available to the right.

In addition to using the zoom-in, zoom-out, pan-left, and pan-right buttons 1270, 1272, 1274, 1276, the user may use a scroll wheel on the 3D pointer device in a modal manner to select a mode for interacting with the TV Internet browser, e.g., a scrolling mode or a zooming/panning mode. For example, scrolling mode can be the default mode according to one exemplary embodiment. When operating in scrolling mode, the cursor can be displayed in a default representation, e.g., as an arrow on the user interface. While in scroll mode, rotation of the scroll wheel on the 3D pointing device (or other pointing device if a 3D pointer is not used) has the effect of scrolling the content which is currently being viewed by the user vertically, i.e., up and down.

If the user selects the zooming/panning mode, which can for example be accomplished by pressing the scroll wheel down (the scroll wheel also operating in this case as a switch), the user may rotate the scroll wheel in one direction to zoom in and rotate the scroll wheel in the other direction to zoom out. Each rotational increment, or click, of the scroll wheel can increase or decrease the zoom level of the displayed content on the screen when the pointing device is operating in the zooming/panning mode. According to one exemplary embodiment, the icon or image used to represent the cursor may be changed when the TV Internet browser is operating in zooming/panning mode as opposed to scrolling mode. For example, as shown in FIG. 11(s), the zooming/panning mode is indicated by zoom indicator 1280 as opposed to an arrow being displayed as the cursor when in scrolling mode. When in zooming/panning mode, the content of the displayed web page on the TV Internet browser can be panned by, for example, depressing and holding down a button on the pointing device and moving the cursor left or right, effectively “dragging” the screen to one side or the other. That is, the panning can be performed in a manner such that the displayed web content appears be “dragged” under a camera. Alternatively, the panning can be performed in a manner such that a camera appears to be “flying over” the displayed web content. As used herein, the term “zooming” can be defined as progressively scaling and displaying content to provide a visual impression of movement toward or away from a user. Similarly, “panning” can be defined as progressively translating and displaying content to give the impression of lateral movement of the content. The user can change back to scrolling mode by pressing the scroll wheel down again, resulting in the cursor being displayed again as an arrow. Use of the scroll wheel on the 3D pointer device in this manner may become second nature to the user thereby enabling rapid changes between scrolling content, and zooming and panning content.

The toolbar 1122 includes an onscreen keyboard button 1140. The user may position the cursor 1120 over the onscreen keyboard button 1140 and actuate the onscreen keyboard button 1140. Upon actuation of the onscreen keyboard button 1140, an onscreen keyboard 1284 (FIG. 11(u)) may be displayed. The onscreen keyboard overlays the display window 1284. When a user actuates a character on the onscreen keyboard 1284, e.g., positions the cursor 1120 over the character button and actuates the character button, that character is entered and displayed in a selected input dialog of the content displayed in the display window 1102, e.g., entered and displayed in a text box on a webpage. The user may repeat this process to enter text into the input dialog, e.g., a search string into a text box of a search engine webpage. It should be noted that by displaying the onscreen keyboard button 1284 with the input dialog in its original format, e.g., not an unformatted input screen, suggested text may still be displayed, e.g., suggested text in a drop down menu below the text box may still appear as characters are entered.

In addition to actuating characters on the onscreen keyboard 1284, the user may use another suitable input device to enter text, e.g., use a keypad provided on the 3D pointer device or a physical keyboard. The user may also use a combination of actuating characters and using another suitable input device to enter text into the input dialog.

In addition to using the onscreen keyboard button 1140, a user may cause the onscreen keyboard 1284 to be displayed using an input dialog mode. In this exemplary embodiment, a user may use the input dialog mode by positioning the cursor 1120 over an input dialog of content displayed in the display window 1102 and actuating entry into the input dialog, e.g., clicking in a text box displayed on a webpage.

The operation of the input dialog mode is described with reference to FIGS. 11(v)-(w). For example, suppose that a user has navigated to a search engine page which includes a text box 1300 into which text search terms can be input. Upon actuating entry into the input dialog, e.g., by positioning a cursor 1120 over the text box 1300 or clicking when the cursor is positioned over the text box 1300, the onscreen keyboard 1284 is displayed as shown in FIG. 11(w). Additionally, the content currently displayed in the display window 1102 is made larger, e.g., the display window 1102 zooms-in the webpage automatically as a result of a user indicating a desire to enter text into the text box 1300 in order to make that process easier for the user. In addition, the input dialog is positioned at a substantial center of the visible (as measured with display of the onscreen keyboard 1284) portion of the display window 1102, e.g., the display window 1102 is panned to substantially center the text box in the center of the visible portion of the display window 1102. At a minimum, the TV Internet browser may if possible automatically relocate the text box 1300 so that the entire box is the displayed portion of the screen to facilitate text entry. For example, in this exemplary embodiment, the input dialog is vertically arranged with approximately ⅓ of the space of the display window 1102 (as measured without display of the onscreen keyboard 1284) above the input dialog and approximately ⅔ of the space of the display window 1102 (as measured without display of the onscreen keyboard 1284) below the input dialog. It should be noted that if the input dialog is arranged at an edge, e.g., top or right side, of the content, then the input dialog may be less substantially centered in the visible portion of the display window. It should also be noted that by positioning the input dialog at the substantial center of the visible portion of the display window 1102, the onscreen keyboard 1284 is kept from overlapping the selected input dialog.

The user may actuate characters, use another suitable device to enter text, or use a combination thereof to enter text into the input dialog. Then, the user may actuate the entered text. Upon actuation of the entered text, the entered text is submitted (or otherwise processed depending on the content), the onscreen keyboard 1284 disappears, and the content displayed in the display window 1102 is made smaller, e.g., the display window 1102 zooms-out the webpage to the default zoom level.

### Button Mapping for FLASH in a Zoomable Internet Browser

According to other exemplary embodiments, implementing a TV Internet Browser having, among other features, zooming capabilities for navigating the displayed web content results in other challenges. For example, according to one exemplary embodiment described above, it may be desirable to enable a user to go back to a previously displayed web page by using a button on a 3D pointing device, e.g., button 304. However some Internet browser plug-ins, e.g., Adobe's FLASH player, Microsoft's Silverlight, etc., take a lot of control from an operating system or application when used to display content, e.g., full screen video. Thus, when a user actuates, for example, an embedded FLASH movie which is available on a web page that he or she is browsing using the TV Internet Browser according to the aforedescribed exemplary embodiments, the displayed movie may occupy the whole screen thereby obscuring the on-screen controls available on the toolbar 1122. Moreover, the FLASH plug-in may operate to discard or disregard inputs such as button presses sent from the 3D pointing device 300. Thus, when a user using the TV Internet Browser described above actuates, for example, a full-screen FLASH content object and, subsequently, presses the “back” button 304 on the 3D pointing device 300 (expecting to be returned to the web page from which the FLASH content was launched), the FLASH player may disregard the command, thereby frustrating the user's intent to cease watching the video.

Thus, according to a further exemplary embodiment, a TV Internet Browser can include a software application that modifies and enhances the behavior of the 3D pointing device 300 when it is attached to, e.g., a TV or system controller associated with a TV, for providing user inputs to the TV Internet browser. This software application operates to remap the outputs of one or more of the buttons 302, 304, 306 to address issues associated with plug-ins like FLASH.

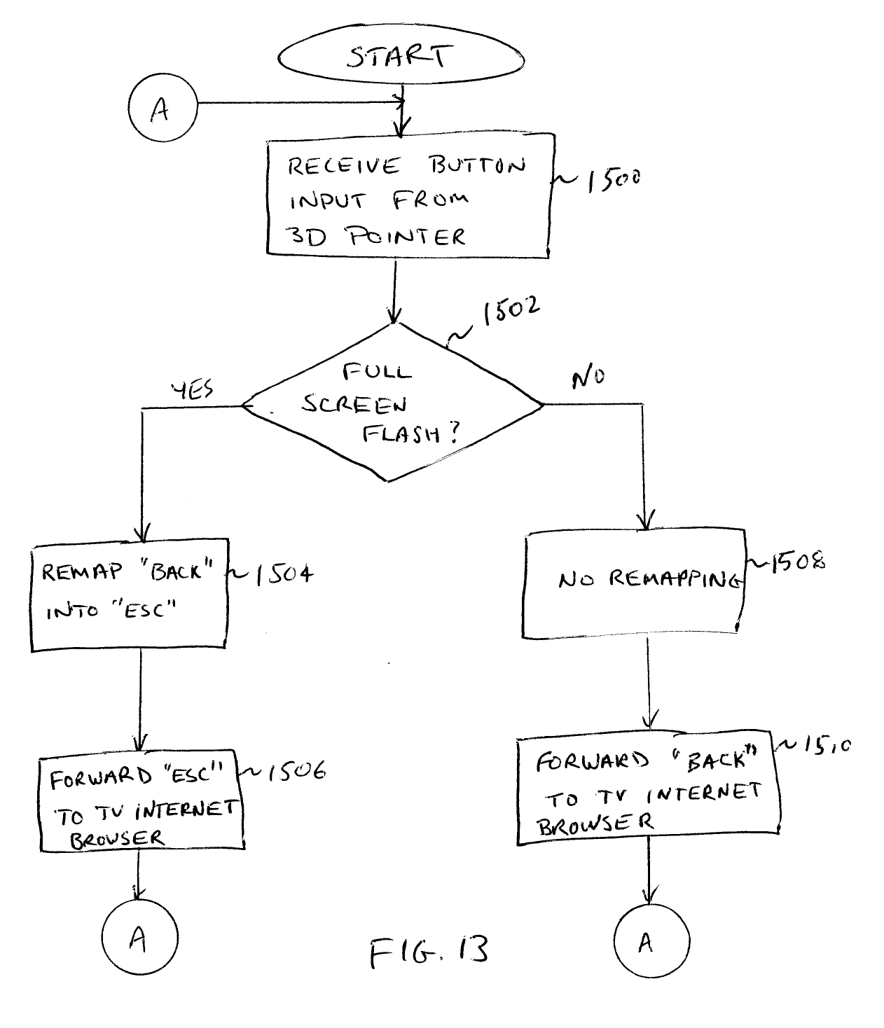

For example, as shown in FIG. 12, a remapping function 1402 can be provided between the output of the 3D pointer 1400 and the input to the TV Internet browser 1404. According to one exemplary embodiment, the remapping function 1402 can be implemented in software and can operate on either a processor disposed within the 3D pointer 1400 or a processor associated with the system which displays the TV Internet Browser 1404, e.g., a system controller which receives inputs from the 3D pointer 1400 over a wireless or wireline interface as described previously.

The remapping function 1402 can perform one or more remappings of outputs from the 3D pointer 1400. One such mapping is shown in the flowchart of FIG. 13, wherein the remapping is performed selectively depending upon whether the TV Internet Browser 1400 is operating using a predetermined plug-in (e.g., FLASH, Silverlight, or the like) to generate full-screen content, or not. Therein, at step 1500, the remapping function 1402 receives a button input from the 3D pointing device 1400. The remapping function 1402 then determines, for example, whether full screen FLASH content (or the like) is being displayed by the TV Internet Browser 1404, e.g., on a television 320 at step 1502. In order to do this, when the remapping function 1402 receives an event that has been set to be handled, it uses Windows APIs to get the frontmost window, e.g., by calling GetForegroundWindow( ). The remapping function 1402 then compares that window to be sure the foremost window is in the same process as the TV Internet Browser. Next, the remapping function 1402 checks the class name of this window, e.g., by calling GetClassName( ).

If the foremost window is a fullscreen FLASH object, the remapping function 1402 operates to remap a selected output from the 3D pointer 1400 into a command that the plug-in will recognize as a termination command at step 1504. As one non-limiting example, the remapping function 1402 could remap a “Back” command (e.g., generated by the 3D pointing device 1400 as a result of its detection that the user has pressed the right button 304 in conjunction with its usage as an input device to the TV Internet Browser 1400) into an “ESC” key command, i.e., which FLASH recognizes as a terminate command. The “ESC” key command is then forwarded, at step 1506, to the TV Internet Browser 1404, and the FLASH content will terminate. Stated differently, if the signal to send based on the input mouse event is the key “BROWSER_BACK” and the class name matches a set of predetermined strings, currently “ShockwaveFlashFullScreen” and “AGFullScreenWinClass” for Flash and Silverlight, respectively, the remapping function 1402 instead sends an “ESC” key.

Otherwise, if the remapping function 1402 determines, at step 1502, that the TV Internet Browser 1404 is not currently running a predetermined plug-in in a predetermined mode (e.g., FLASH in full-screen mode), then the remapping function will not remap the received input (step 1508). Instead the remapping function will send the unremapped key input on to the TV Internet Browser 1404 as shown in step 1510. The remapping can also be window based in a Windows environment, e.g., the main browser window will receive a “Back” command in response to a right button press, while a Full Screen Flash window will receive an “Esc” command in response to a right button press.

The exemplary embodiment shown in FIG. 13 and described above can be further generalized to consider other types of remappings associated with other types of “controlling” plug-ins or applications which may operate in conjunction with a TV Internet Browser. Considered at a higher level, such plug-ins or applications may operate based on the presumption that a keyboard is attached to the system on which the Internet Browser is operating. While this may be true for PC based implementations, it may or may not be true for TV based browser implementations where users are used to using only a remote device. Thus viewed more generally, an exemplary method according can be formulate as: detecting that a predetermined plug-in or application is running in a predetermined mode within a TV Internet Browser and, in response to this detection, remapping an input to the TV Internet Browser from a first, non-operative value into a second value which is operative relative to the predetermined plug-in or application. According to some exemplary embodiments, the remapping function can operate to consume events (e.g., button presses) and send no signal or message to the TV Internet Browser in response to the received event.

Another form of remapping according to exemplary embodiments is associated with the aforedescribed panning and zooming features. Since plug-ins like FLASH typically ignore or effectively disable mouse button presses, it becomes significant to continue to enable the TV Internet Browser to register such events since they are used to control zooming and panning as described above. For example, when a user “drags” the screen to the right to pan the displayed web content, a FLASH window may appear on the screen and the continuous depression of the button on the 3D pointing device which is used to perform the pan (as described above) may become unrecognized by the system. According to exemplary embodiments, when a process associated with the TV Internet Browser 1404 is in focus (operative) such that it needs information associated with motion of the 3D pointer, button presses, scroll wheel rotation or scroll wheel presses for reasons described above, e.g., when the TV Internet Browser 1404 enters the pan/zoom mode, the process can register with the remapping function 1402 to receive such inputs to enable, for example, the panning to occur even over a FLASH window which would otherwise be unresponsive to such inputs. When exiting a relevant mode, e.g., pan/zoom mode, the process can unregister for such event information.

To provide some additional detail, but recognizing that the following is still an illustrative, exemplary embodiment, the remapping function can be implemented as an XPCOM object, built and distributed with the TV Internet Browser as a shared library and an xpt file, with the TV Internet Browser being implemented as an xulrunner application—i.e., a browser based on Mozilla's Gecko engine. In this exemplary embodiment, the remapping function exposes its API to xul, the combination of javascript and xml used to describe the layout and functionality of the browser. An exemplary remapping function API can be written as:

interface MouseEventCallback : nsISupports
{

void MouseEvent(in short eventType, in short mouseX, in short

mouseY, in short mouseDx, in short mouseDy);
};
interface IFSTool : nsISupports
{

// processName is ignored right now
void RemapButton(in string processName,

in short inputEvent,
in short outputEvent);

void UnmapButton(in string processName,

in short inputEvent);

attribute MouseEventCallback objCallback;

};

According to this exemplary embodiment, the remapping function 1402 stores a mapping from an input event to an output event and allows Javascript to configure these mappings. The list of input events available for remapping according to this exemplary embodiment are:

// Mouse Event Types

| const short WM_LBUTTONDOWN = 0x201; //Left mousebutton down | |
|---|---|
| const short WM_LBUTTONUP = 0x202; //Left mousebutton up | |
| const short WM_LBUTTONDBLCLK = 0x203; //Left mousebutton doubleclick | |
| const short WM_RBUTTONDOWN = 0x204; //Right mousebutton down | |
| const short WM_RBUTTONUP = 0x205; | //Right mousebutton up |

| const short WM_RBUTTONDBLCLK = 0x206; //Right mousebutton doubleclick | |
|---|---|
| const short WM_KEYDOWN = 0x100; //Key down | |
| const short WM_KEYUP = 0x101; | //Key up |

const short WM_MBUTTONDOWN = 0x0207;
const short WM_MBUTTONUP = 0x0208;
const short WM_MBUTTONDBLCLK = 0x0209;
const short WM_MOUSEWHEEL = 0x020A;

The list of output events is the set of virtual keys defined in winuser.h, including, for example, every alphanumeric key, Function keys, modifiers (ctrl, shift, alt), and other non-standard keys such as browser, volume, and media controls. Additionally, the remapping function defines a null event (VK_NO_EVENT), where no key is sent, and the mouse event is simply absorbed by the remapping function as previously described.

When the remapping function 1402 receives an event in its hook, it first checks if there has been a mapping established by the TV Internet Browser. If not, it simply ignores the event, and lets Windows handle it. Otherwise, it checks if the event has been mapped to something other than the null event. If so, it creates 2 Windows keyboard input events, i.e., one to send a fake input that the key is down, followed immediately by an input that the key was released.

Systems and methods for processing data according to exemplary embodiments of the present invention can be performed by one or more processors executing sequences of instructions contained in a memory device. Such instructions may be read into the memory device from other computer-readable mediums such as secondary data storage device(s). Execution of the sequences of instructions contained in the memory device causes the processor to operate, for example, as described above. In alternative embodiments, hard-wire circuitry may be used in place of or in combination with software instructions to implement the present invention.

Numerous variations of the afore-described exemplary embodiments are contemplated. The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, used herein, the article “a” is intended to include one or more items.

1. A system comprising:
a television;
a TV Internet browser using said television to display web pages from said Internet;
a processor associated with said television and configured to receive inputs for controlling said TV Internet browser;
wherein when said processor receives a button press input associated with a predetermined command, said processor determines whether a currently viewed web page on said TV Internet browser is running a predetermined plug-in in a predetermined mode and, if so, remapping said button press input from said predetermined command to another command which is intended to terminate said predetermined plug-in and sending said another command to said TV Internet browser, otherwise, if not, sending said back command to said TV Internet browser.

2. The system of claim 1, wherein said processor is disposed within an input device.

3. The system of claim 1, wherein said processor is disposed within a system controller connected to said television.

4. The system of claim 2, wherein said predetermined command is a back command which is intended to return said TV Internet browser to a previously viewed web page.

5. The system of claim 1, wherein said predetermined plug-in is one of FLASH and SILVERLIGHT.

6. The system of claim 5, wherein said predetermined mode is full screen.

7. The system of claim 2, wherein said input device is a 3D pointing device.

8. The system of claim 1, wherein said input device is a keyboard.

9. A method for remapping button press inputs to a TV Internet browser, the method comprising:
receiving a button press input associated with a predetermined command;
determining whether a currently viewed web page on said TV Internet browser is running a predetermined plug-in in a predetermined mode;
if so, remapping said button press input from said predetermined command to another command which is intended to terminate said predetermined plug-in and sending said another command to said TV Internet browser; and
if not, sending said back command to said TV Internet browser.

10. The method of claim 9, wherein said predetermined command is a back command which is intended to return said TV Internet browser to a previously viewed web page.

11. The method of claim 9, wherein said predetermined plug-in is one of FLASH and SILVERLIGHT.

12. The method of claim 9, wherein said predetermined mode is full screen.

13. The method of claim 9, wherein said step of receiving a button press input further comprises receiving a button press input from a 3D pointing device.

14. The method of claim 9, wherein said step of receiving a button press input further comprises receiving a button press input from a keyboard.

15. A system controller comprising:
a processor configured to receiving a button press input associated with a predetermined command, to determine whether a currently viewed web page on a TV Internet browser is running a predetermined plug-in in a predetermined mode and,
if so, remapping said button press input from said predetermined command to another command which is intended to terminate said predetermined plug-in and sending said another command to said TV Internet browser; and
if not, sending said back command to said TV Internet browser.

16. The system controller of claim 15 wherein said predetermined command is a back command which is intended to return said TV Internet browser to a previously viewed web page.

17. The system controller of claim 15, wherein said predetermined plug-in is one of FLASH and SILVERLIGHT.

18. The system controller of claim 15, wherein said predetermined mode is full screen.

19. The system controller of claim 15, wherein said button press input is from a 3D pointing device.

20. The system controller of claim 15, wherein said button press input is from a keyboard.
